(19) United States
(12) Patent Application Publication
(10) Pub. No.: US 2026/0038240 A1
(43) Pub. Date: Feb. 5, 2026

(54) Classifier Evaluation Using Sum Estimation

(71) Applicant: Coactive Systems Inc., San Jose, CA (US)

(72) Inventors: Stephen Oscar Mussmann, Marietta, GA (US); Kavya Tumkur, San Francisco, CA (US); Mehul Smriti Raje, Mountain View, CA (US)

(73) Assignee: Coactive Systems Inc., San Jose, CA (US)

(21) Appl. No.: 19/287,097

(22) Filed: Jul. 31, 2025

Related U.S. Application Data
(60) Provisional application No. 63/678,018, filed on Jul. 31, 2024.
(60) Provisional application No. 63/748,410, filed on Jan. 22, 2025.

(51) Int. Cl. G06V 10/764; G06F 17/16; G06V 10/762; G06V 10/776; G06V 10/82

(52) U.S. Cl. CPC G06V 10/764; G06F 17/16; G06V 10/763; G06V 10/776; G06V 10/82

(57) ABSTRACT

For example, some methods for evaluation of classifier using sum estimation may include accessing at least a part of a corpus of vectors that has been partitioned into vector datasets of different sizes, wherein the corpus of vectors has an order based on an inner product of a vector from the corpus of vectors with a vector of classifier parameters; forming a sample of the corpus of vectors by selecting, from at least two of the vector datasets, up to K vectors that are closest to an end of the order within their respective vector dataset, wherein K is an integer; identifying vectors in the sample satisfying a condition; and determining an estimate of a count of vectors satisfying the condition in the corpus of vectors based on a weighted count of the identified vectors in the sample.

### CROSS-REFERENCE TO RELATED APPLICATION(S)

This application claims the benefit of U.S. Provisional Application No. 63/678,018, filed on Jul. 31, 2024, which is incorporated herein by reference in its entirety. This application claims the benefit of U.S. Provisional Application No. 63/748,410, filed on Jan. 22, 2025, which is incorporated herein by reference in its entirety.

### TECHNICAL FIELD

Some embodiments pertain to classifier evaluation using sum estimation.

### BACKGROUND

Training an image classification engine is a cumbersome process. According to some schemes, users manually provide hundreds or thousands of positive and negative examples in order to train the image classification engine. Less cumbersome techniques for image classification may be desirable. The Hierarchical navigable small world (HNSW) algorithm is a graph-based approximate nearest neighbor search technique.

### BRIEF DESCRIPTION OF THE DRAWINGS

FIG. 1 illustrates the training and use of a machine-learning program, in accordance with some embodiments.

FIG. 2 illustrates an example neural network, in accordance with some embodiments.

FIG. 3 illustrates the training of an image recognition machine learning program, in accordance with some embodiments.

FIG. 4 illustrates a convolutional neural network, in accordance with some embodiments.

FIG. 5 is a block diagram of a computing machine, in accordance with some embodiments.

FIG. 6 is a flowchart of an example of a technique for classifier evaluation using sum estimation, in accordance with some embodiments.

FIG. 7 is a flowchart of an example of a technique for selecting up to K vectors from each vector database in a set of vector databases of different sizes storing a partition of a corpus of vectors to form a sample of the corpus of vectors, in accordance with some embodiments.

FIG. 8 is a flowchart of an example of a technique for identifying vectors in a sample satisfying a condition, in accordance with some embodiments.

FIG. 9 is a flowchart of an example of a technique for determining an estimate of a count of vectors satisfying a condition in a corpus of vectors, in accordance with some embodiments.

FIG. 10 is a flowchart of an example of a technique for determining whether to continue training classifier based on an estimate from an evaluation of the classifier, in accordance with some embodiments.

FIG. 11 is a flowchart of an example of a technique for adding new vectors to a corpus of vectors in a manner that randomly or pseudo-randomly partitions the corpus of vectors into a set of vector databases, in accordance with some embodiments.

FIG. 12 illustrates an example of sampling a set of vector databases storing a partition of a corpus of vectors into vector databases of different sizes.

FIG. 13 illustrates an example of a user interface for classifier evaluation using sum estimation, in accordance with some embodiments.

FIG. 14 is a flowchart of an example of a technique for classifier evaluation using sum estimation, in accordance with some embodiments.

FIG. 15 is a flowchart of an example of a technique for selecting up to K vectors from each vector dataset in a set of vector datasets of different sizes storing a partition of a corpus of vectors to form a sample of the corpus of vectors, in accordance with some embodiments.

FIG. 16 is a flowchart of an example of a technique for presenting an indication of quality assessment for a classifier, in accordance with some embodiments.

FIG. 17 is a flowchart of an example of a technique for classifier evaluation using sum estimation, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

According to some schemes, training an image classification engine is a cumbersome process. For example, to train an image classification engine to classify images as “elephant” or “not elephant” may require human users to manually identify and provide thousands of positive example images of “elephant” and negative example images of “not elephant.” This is a cumbersome process that may be prohibitively expensive (in terms of human labor costs) for some classification tasks. Conventionally, developers of classifiers use a held-out testing set of manually annotated data points to see if their predictive model is performing well or not. Typically, these test sets need to have hundreds or thousands of data points. In some settings, this can be a burdensome number of data points to collect.

Some implementations disclosed herein address the above problems by using a sum estimation technique (e.g., a statistical approach that estimates the sum of values across a large dataset by analyzing a strategically selected sample) to evaluate a classifier by estimating a distribution of classification confidences for a classifier operating on a given corpus of vectors (e.g., vector embeddings of images, audio, or words). For example, in a binary classifier, if most of the predictions of the classifier are in a high confidence range (e.g., 75% to 100%, or 0% to 25%), then the classifier may be evaluated as strong or well trained. On the other hand, if most of the predictions of the classifier are in a low confidence range (e.g., 25% to 75%), then the classifier may be evaluated as weak or poorly trained. If the evaluation is strong, training processes may be discontinued to conserve time and computing resources. If the evaluation of the classifier is poor, then additional resources may be selectively applied to continue training and/or otherwise adjust a classifier model. In some implementations, the evaluation may be used to decide whether or how to deploy a classifier and/or for informational purposes. Some of the systems and techniques described herein may enable computationally efficient evaluation of a classifier on a large data set (e.g., including millions of vectors representing inputs), and may address the issue of evaluating a predictive model by without needing to collect a manually annotated test set.

Some systems and techniques described herein combine random sampling of a corpus of vectors with a focus on extrema within subsamples of various sizes to robustly estimate counts at a wide range of levels of population frequencies (i.e., the frequency or prevalence of vectors satisfying particular conditions within an overall corpus of data) while using reasonably sized samples to keep computational complexity low. The corpus of vectors may be randomly (or pseudo-randomly) partitioned into multiple vector databases (e.g., Qdrant, Pinecone, Databricks vector search databases) of different sizes. These vector databases may be indexed (e.g., using locality sensitive hashing, clustering-based, HNSW indexing) to enable efficient nearest neighbor search within each database of the partition using a query vector (e.g., a vector of classifier parameters to be evaluated, a vector selected from the dataset itself, or any external vector with the same dimensions as the vectors in the dataset) to quickly find extrema within each database of the partition. A hyperparameter, K, limits the number of vectors included in a sample from each of the databases and thus the total number of vectors included in sample of the corpus of vectors, which is a union of the samples from each vector database. The vectors in the combined sample may be sorted (e.g., in ascending or descending order) using an ordering based on the inner product with the query vector. In some implementations, an estimate of a count of vectors satisfying a condition (e.g., a condition on the inner product corresponding to a maximum or minimum probability prediction for the classification) in the corpus of vectors may be determined based on a weighted count of vectors in the sample that satisfy the condition. For example, the weights used to determine the estimate may be inversely proportional to a probability of assignment of vectors to a subset of the set of vector databases that are available to provide samples. This estimate may be determined based on an analysis of few datapoints relative to the size of the corpus of vectors, while still providing a robust estimate of a count of vectors in the whole corpus satisfying the condition. In some implementations, the estimate may be used to efficiently evaluate the training and performance of the subject classifier.

For example, consider the following scenario, which illustrates how some implementations estimate the distribution of vectors satisfying different probability thresholds in a large corpus by examining a sample strategically selected from partitioned databases.

Suppose we have an ordered set of n values/items X=(x₁, x₂, . . . xₙ).
For each xᵢ, we sample a “rarity” rᵢ as a geometric distribution with p=1/2.
There is a function ƒ:x [symbol] [symbol] ₊ such that i≤j⇒ƒ(xᵢ)≥ƒ(xᵢ). Denote ƒᵢ=ƒ(xᵢ).
Suppose there is an oracle that can return the first k elements of {xᵢ|rᵢ=r} for any rarity r ∈ [symbol] .
Define

$${F}_{i} = {\sum }_{j = 1}^{i} {f}_{j}$$

and our goal is to estimate the total F:=Fₙ.

In some implementations, the following estimator may be applied in such scenario.

The algorithm has a hyperparameter: k.

$${A}_{i} = \{ r : {\sum }_{j = 1}^{i - 1} 1 [ {r}_{j} = r ] < k \} \qquad ( 1 )$$

$${ω}_{i} = {( Pr ( R ∈ {A}_{i} ) )}^{- 1} \qquad ( 2 )$$

$${I}_{i} = 1 [ {r}_{i} ∈ {A}_{i} ] \qquad ( 3 )$$

Define the estimate eᵢ=Iᵢƒᵢwᵢ so conditioned on the previous rarities being sampled:

$$𝔼 [ {e}_{i} ] = {f}_{i} and {E}_{i} = {\sum }_{j = 1}^{i} {e}_{j} .$$

Our final estimate is E:=Eₙ.

Equation (1) defines the set of unsaturated vector datasets from which sample of the corpus of data is drawn for a condition threshold corresponding to the its vector in the sorted corpus of data, Equation (2) shows how weights used to determine an estimate based on the vectors in the strategically selected sample may be determined based on the database assignment probabilities of the unsaturated vector datasets, and Equation (3) describes the selective application of the weights to vectors from the unsaturated vector datasets.

In some implementations, a caboose vector may be identified for a sample from one of the vector databases to facilitate efficient determination of the estimate of the count for the corpus of vectors using appropriate weights for vectors satisfying the condition from various subsets of the partition. A caboose vector may be the last vector included from a vector dataset in the sample, and may be used as trigger point for changing the weightings in the algorithm. For example, caboose vectors for a vector dataset with corresponding rarity, r, may be defined as follows.

Define the caboose for rarity r as

$${C}_{r} = min \{ c : {\sum }_{i = 1}^{c} 1 [ {r}_{j} = r ] \leq k \} and ∞ if {\sum }_{i = 1}^{n} 1 [ {r}_{j} = r ] < k .$$

In some implementations, these techniques may be applied to evaluate a classifier based on a logistic regression model. Consider a corpus of vectors, X, of 1024-dimensional vectors with ∥x∥=1 (e.g., normalized embedding vectors). The classifier may be applied as:

$$Pr ( y = 1 \vert x ) = Sigmoid ( w \cdot x + b )$$

w·x+b=0 (specifies a hyperplane decision boundary)
   where y is a binary classification output by the classifier, w is a vector of classifier parameters, w·x is the vector dot product or inner product of w with a vector, x, from the corpus of vectors, and b is a scalar parameter of the classifier.

It follows that Max Pr(y=1|x) <-> Max w·x, i.e., finding vectors with maximum probability of being classified as positive is equivalent to finding vectors with the maximum inner product with the classifier parameters. This condition may be efficiently computed using nearest neighbor search functions of each vector database (e.g., Qdrant, Pinecone, Databricks vector search) in a partition of the corpus of vectors. These vector databases may use various types of indexing to expedite search functions, such as, locality sensitive hashing, clustering-based, HNSW. Although many variants of HNSW exist, in its simplest form, the method constructs a graph where the vectors are nodes and edges connect nearby vectors. Search may be performed using a greedy local optimization procedure from a randomly selected initial vector. Due to local minima, HNSW has no retrieval guarantees, but empirically HNSW may have high retrieval recall compared to competing methods for a fixed computational budget.

These techniques may enable efficient computation of answers to questions about the classifier in relation to the corpus of vectors, such as:
How many x are there so that Pr(y=1|x)>0.75?
How many x are there so that w·x>0.4?

For example, there may be 3 million vectors in the corpus of vectors. Each will have a w·x value, such as, 0.55, 0.53, . . . , 0.41, 0.39, . . . , 0.35. If I get top 100 w·x, and only 60 of them are above 0.4, then the answer to the question is 60. Works well if less than 1000 such vectors. Now consider drawing a random sample of 10,000 random x's, and then estimate proportion that have w·x>0.4. This approach may work well if more than 100,000 such x's. But what if 30,000 such x's have w·x>0.4? If, beforehand, we had sampled 1 in 128 of the 3 million and put in a vector database: 24,000 total vectors, 234 have w·x>0.4.

In some implementations, while building the dataset, we partition the corpus of vectors into 20 vector databases with a geometric distribution with p=0.5:
½ chance of going in first vector DB
¼ chance of going in second vector DB
⅛ chance of going in third vector DB
1/128 chance of going in seventh vector DB
1/256 chance of going in eighth vector DB
. . .

Some implementations may provide advantages over conventional techniques for classifier evaluation, such as, providing more accurate classifier evaluations for a given computation resource budget and/or providing classifier evaluations using less computational resources (e.g., memory and/or flops). Some practical applications where efficient classifier evaluation may be critical, include in-field training in mobile devices with limited computational resources, in real-time systems, or extremely large corpuses of data (e.g., on-line shopping datasets). These techniques may also be used by agentic, transformer-based language models that may utilize specialized and dynamically trained classifiers to complete tasks on large corpuses of data.

For example, lots of problems with an evaluation function of the form sum_x(f(w·x)) may be addressed using systems and techniques described herein. For example, consider a large language model with 100,000 words in a vocabulary. Pr(select word x) may be proportional to exp(w·x). For example, Pr(select “the”) may be set to exp(w·“the”)/(sum_x exp(w·x)), where the denominator in this expression may be efficiently evaluated using systems and techniques described herein.

In some cases, it is desirable to not only get the top elements, but also to estimate the sum of a function evaluated on all points (e.g., kernel density estimate contribution from single point) in a large corpus of data. Some implementations may provide an algorithm to provably estimate the sum of a function if we have access to the elements that maximize the function, given a pre-computed data structure. Consider a set of n vectors X, a query vector q, similarity function f: x,q->R+ (e.g., Kernel Density Estimation (KDE) contribution, logistic regression model's expected positives, unnormalized probability), i.e., the similarity function takes a vector x and query vector q as inputs and outputs a non-negative real number. A goal is, given q, quickly estimate the sum over X of f(q, x).

Some examples of problems in this class include: 1) Estimate number of images with predicted probability greater than 0.75, i.e., the sum over X of 1[Pr(y=1|x)>0.75], where f(q=(w,b),x)=1[sigmoid(w·x+b)>0.75]; 2) estimating an expected number of positives for a logistic regression, i.e., E[positives]=sum over X of Pr(y=1|x)=sum over X of sigmoid(w·x+b), where f(q=(w,b),x)=sigmoid(w·x+b); 3) KDE, i.e., kde(q)=1/n*sum over X of Pr(Normal(x, sigma^{∧}2 I)=q), where sigma is the bandwidth of the kernel and f(q,x)=exp (−∥q−x∥^{∧}2/(2*sigma^{∧}2)); 4) large softmax, i.e., Pr(x′) is proportional to exp(q·x′/T) and Pr(x′)=exp (q·x′/T)/(sum over X of exp (q·x/T)), where f(q,x)=exp (q·x/T); and 5) counting points closer than a distance threshold. i.e., f(q,x)=1[∥x−q∥<0.3] or f(q,x)=1[∥x−q∥≤0.3].

In some implementations, a “level” or “rarity”, corresponding to one of the vector datasets that a corpus of vectors is partitioned into, may be assigned to each data point x, where the probability of level one is decaying exponentially (level 1: ½, level 2: ¼, level 3: ⅛, . . . ). The top k elements x (according to f(x,q)) may be retrieved from each level. An estimator may be constructed based on just those elements, where there are O(k*log (n)) such elements, i.c., the number of considered elements for the estimation process scales linearly with the hyperparameter k and logarithmically with the size, n, of the overall corpus of vectors under consideration.

Some examples of experiments where these techniques could be applied include: synthetic (every element has function value either 0 or 1); KDE (using Open Images with ResNet50 embeddings); Softmax (using OpenImages with OAI CLIP embeddings for class-based text queries); and Sigmoid (logistic regression classifiers trained on OpenImages with ResNet50 embeddings). Baselines for comparison may include: random sample; TopK; and hybrid methods that blend random samples with TopK. Metrics for evaluating the performance on an estimator on these experiments may include: relative error of estimate compared to a true sum; a simplified cost=(#random_samples)+{1,5, 10, 20}*(#topk_returned_elements).

Hierarchical navigable small world (HNSW) methods may have exponential-random levels, which could integrate with some of the proposed estimation techniques. The cost of random samples versus topk elements is non-linear and the ratio of costs depends on many system design concerns. Some implementations may have much better asymptotic cost. For example, some conventional approaches may require sqrt(n)/ε^{∧}2 cost, while some implementations described herein may requires log (n)/ε2 cost, where ε is an error tolerance for an application and n is the size of the corpus of data for analysis.

Aspects of the present technology may be implemented as part of a computer system. The computer system may be one physical machine, or may be distributed among multiple physical machines, such as by role or function, or by process thread in the case of a cloud computing distributed model. In various embodiments, aspects of the technology may be configured to run in virtual machines that in turn are executed on one or more physical machines. It will be understood by persons of skill in the art that features of the technology may be realized by a variety of different suitable machine implementations.

The system includes various engines, each of which is constructed, programmed, configured, or otherwise adapted, to carry out a function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, cach of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

As used herein, the term “model” encompasses its plain and ordinary meaning. A model may include, among other things, one or more engines which receive an input and compute an output based on the input. The output may be a classification. For example, an image file may be classified as depicting a cat or not depicting a cat. Alternatively, the image file may be assigned a numeric score indicating a likelihood whether the image file depicts the cat, and image files with a score exceeding a threshold (e.g., 0.9 or 0.95) may be determined to depict the cat.

This document may reference a specific number of things (e.g., “six mobile devices”). Unless explicitly set forth otherwise, the numbers provided are examples only and may be replaced with any positive integer, integer or real number, as would make sense for a given situation. For example, “six mobile devices” may, in alternative embodiments, include any positive integer number of mobile devices. Unless otherwise mentioned, an object referred to in singular form (e.g., “a computer” or “the computer”) may include one or multiple objects (e.g., “the computer” may refer to one or multiple computers).

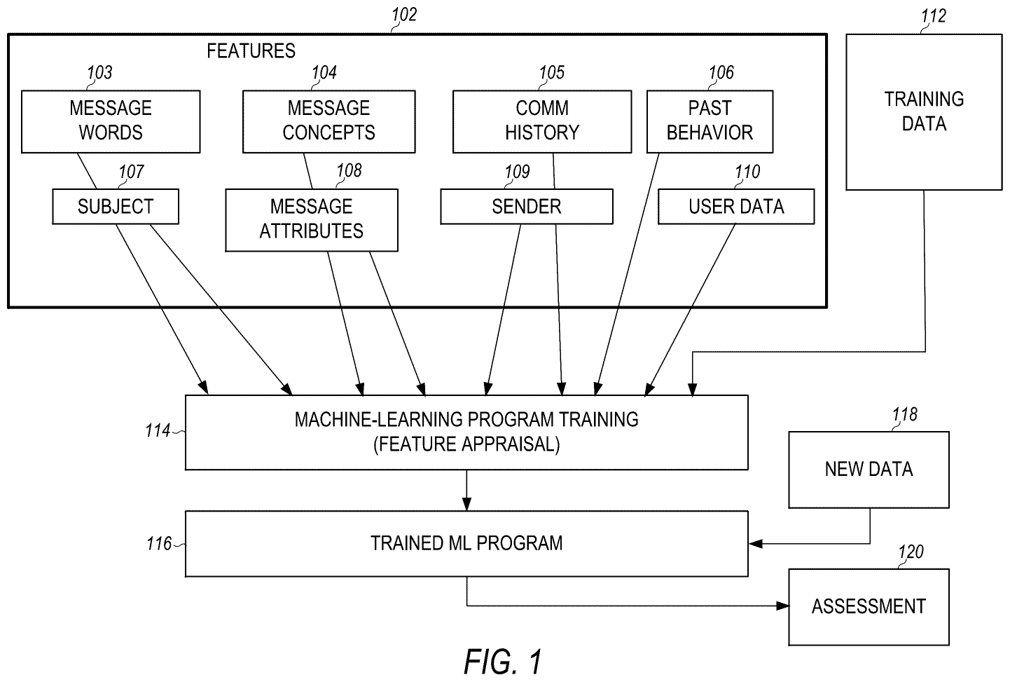

FIG. 1 illustrates the training and use of a machine-learning program, according to some example embodiments. In some example embodiments, machine-learning programs (MLPs), also referred to as machine-learning algorithms or tools, are utilized to perform operations associated with machine learning tasks, such as image recognition or machine translation.

Machine learning is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in machine learning, a computer could be provided with examples of images of elephants and be trained to determine which images have and lack depictions of elephants, without the programmer encoding explicit instructions as to how to identify an elephant. Machine learning explores the study and construction of algorithms, also referred to herein as tools, which may learn from existing data and make predictions about new data. Such machine-learning tools operate by building a model from example training data 112 in order to make data-driven predictions or decisions expressed as outputs or assessments 120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In one example embodiment, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example embodiments, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the machine-learning tool is trained at operation 114. The machine-learning tool appraises the value of the features 102 as they correlate to the training data 112. The result of the training is the trained machine-learning program 116.

When the machine-learning program 116 is used to perform an assessment, new data 118 is provided as an input to the trained machine-learning program 116, and the machine-learning program 116 generates the assessment 120 as output. For example, when a message is checked for an action item, the machine-learning program utilizes the message content and message metadata to determine if there is a request for an action in the message.

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end carly and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs-having reached a performance plateau-the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

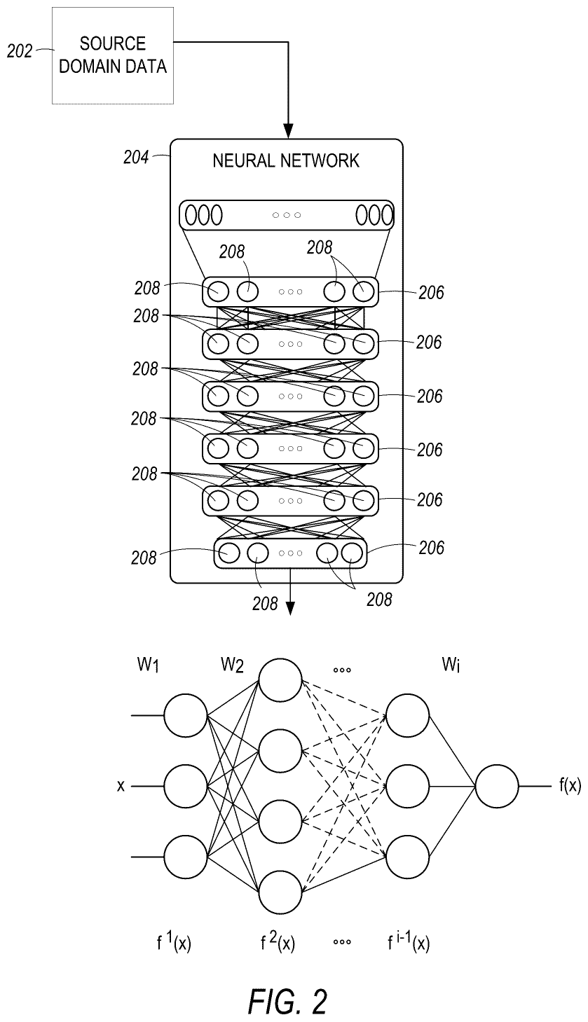

FIG. 2 illustrates an example neural network 204, in accordance with some embodiments. As shown, the neural network 204 receives, as input, source domain data 202. The input is passed through a plurality of layers 206 to arrive at an output. Each layer 206 includes multiple neurons 208. The neurons 208 receive input from neurons of a previous layer and apply weights to the values received from those neurons in order to generate a neuron output. The neuron outputs from the final layer 206 are combined to generate the output of the neural network 204.

As illustrated at the bottom of FIG. 2, the input is a vector x. The input is passed through multiple layers 206, where weights W₁, W₂, . . . , Wᵢ are applied to the input to each layer to arrive at ƒ¹(x), ƒ²(x), . . . , ƒ^{l-1}(x), until finally the output ƒ(x) is computed.

In some example embodiments, the neural network 204 (e.g., deep learning, deep convolutional, or recurrent neural network) comprises a series of neurons 208, such as Long Short Term Memory (LSTM) nodes, arranged into a network. A neuron 208 is an architectural element used in data processing and artificial intelligence, particularly machine learning, which includes memory that may determine when to “remember” and when to “forget” values held in that memory based on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized into tree structures in various configurations of neural networks to provide interactions and relationship learning modeling for how each of the frames in an utterance are related to one another.

For example, an LSTM node serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells carlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

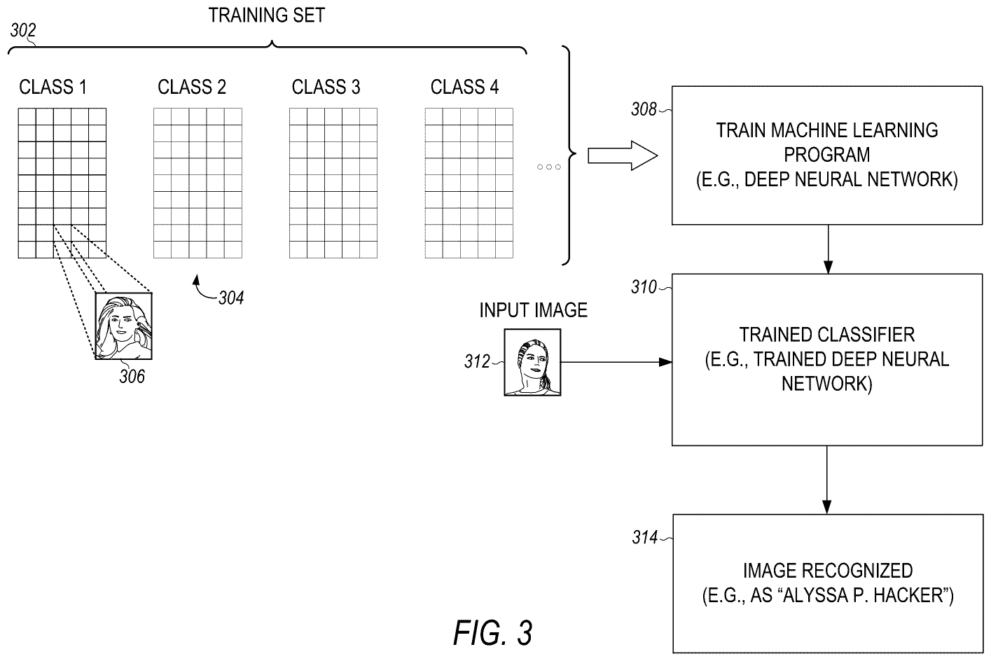

FIG. 3 illustrates the training of an image recognition machine learning program, in accordance with some embodiments. The machine learning program may be implemented at one or more computing machines. Block 302 illustrates a training set, which includes multiple classes 304. Each class 304 includes multiple images 306 associated with the class. Each class 304 may correspond to a type of object in the image 306 (e.g., a digit 0-9, a man or a woman, a cat or a dog, etc.). In one example, the machine learning program is trained to recognize images of various persons (i.e., to map a photograph of a person to the person's name), and each class 304 corresponds to each person, with each individual class 304 corresponding to an individual person (e.g., one class corresponds to Alyssa P. Hacker, one class corresponds to Ben Bitdiddle, etc.). At block 308 the machine learning program is trained, for example, using a deep neural network. At block 310, the trained classifier (e.g., the trained deep neural network), generated by the training of block 308, receives an input image 312, and at block 314 the image is recognized. For example, if the image 312 is a photograph of Alyssa P. Hacker, the classifier recognizes the image as corresponding to Alyssa P. Hacker at block 314. The classifier may include a DNN, as illustrated by the circle with the circular arrows.

FIG. 3 illustrates the training of a classifier, according to some example embodiments. A machine learning algorithm is designed for recognizing faces, and a training set 302 includes data that maps a sample to a class 304 (e.g., a class includes all the images of purses). The classes may also be referred to as labels. Although implementations presented herein are presented with reference to object recognition, the same principles may be applied to train machine-learning programs used for recognizing any type of items.

The training set 302 includes a plurality of images 306 for each class 304 (e.g., image 306), and each image is associated with one of the categories to be recognized (e.g., a class). The machine learning program is trained 308 with the training data to generate a classifier 310 operable to recognize images. In some example embodiments, the machine learning program is a DNN.

When an input image 312 is to be recognized, the classifier 310 analyzes the input image 312 to identify the class (e.g., class 304) corresponding to the input image 312.

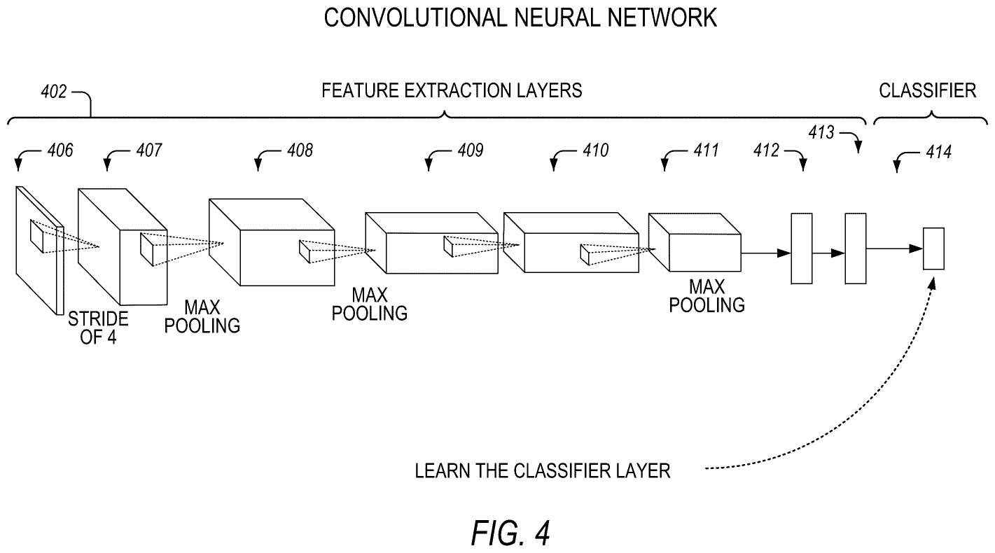

FIG. 4 illustrates a convolutional neural network, according to some example embodiments. Training a classifier of the convolutional neural network may be accomplished with feature extraction layers 402 and classifier layer 414. Each image is analyzed in sequence by a plurality of layers 406-413 in the feature-extraction layers 402.

With the development of deep convolutional neural networks, the focus in face recognition has been to learn a good face embedding-based classifier, in which faces of the same person are close to each other, and faces of different persons are far away from each other. For example, the verification task with the LFW (Labeled Faces in the Wild) dataset has been often used for face verification.

Many face identification tasks (e.g., MegaFace and LFW) are based on a similarity comparison between the images in the gallery set and the query set, which is essentially a K-nearest-neighborhood (KNN) method to estimate the person's identity. In the ideal case, there is a good face feature extractor (inter-class distance is always larger than the intra-class distance), and the KNN method is adequate to estimate the person's identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using this reduced representation instead of the complete initial data. DNN utilizes a stack of layers, where each layer performs a function. For example, the layer could be a convolution, a non-linear transform, the calculation of an average, etc. Eventually this DNN produces outputs by classifier 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407-413. The stride controls how the filter convolves around the input volume. “Stride of 4” refers to the filter convolving around the input volume four units at a time. Max pooling refers to down-sampling by selecting the maximum value in each max pooled region.

In some example embodiments, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

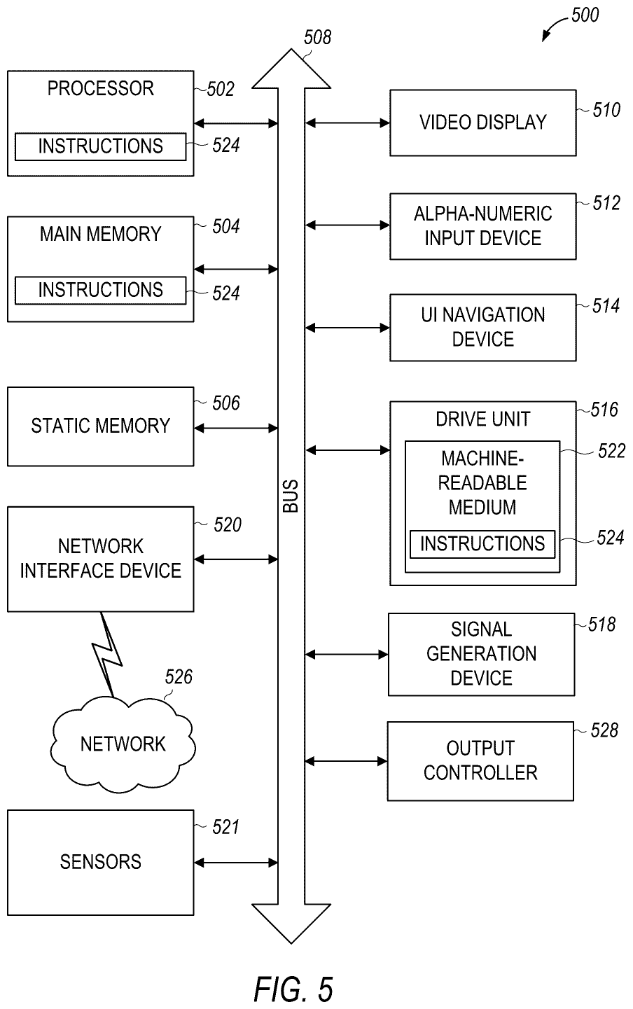

FIG. 5 illustrates a circuit block diagram of a computing machine 500 in accordance with some embodiments. In some embodiments, components of the computing machine 500 may store or be integrated into other components shown in the circuit block diagram of FIG. 5. For example, portions of the computing machine 500 may reside in the processor 502 and may be referred to as “processing circuitry.” Processing circuitry may include processing hardware, for example, one or more central processing units (CPUs), one or more graphics processing units (GPUs), and the like. In alternative embodiments, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. In this document, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (c.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory or non-volatile memory. The computing machine 500 may further include a video display unit 510 (or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device 516 (e.g., a drive unit), a signal generation device 518 (e.g., a speaker), a network interface device 520, and one or more sensors 521, such as a global positioning system (GPS) sensor, compass, accelerometer, or other sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 (e.g., a drive unit) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

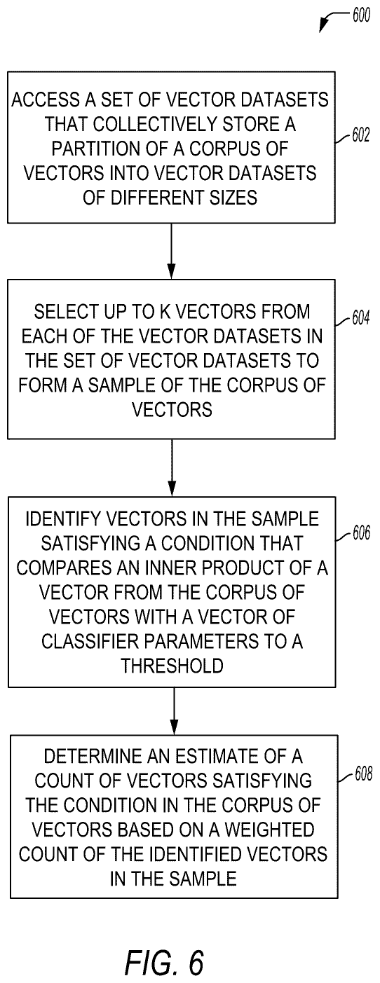

FIG. 6 is a flowchart of an example of a technique 600 for classifier evaluation using sum estimation, in accordance with some embodiments. The technique 600 includes accessing 602 a set of vector databases that collectively store a partition of a corpus of vectors into vector databases of different sizes; selecting 604 up to K vectors from each of the vector databases in the set of vector databases to form a sample of the corpus of vectors; identifying 606 vectors in the sample satisfying a condition that compares an inner product of a vector from the corpus of vectors with a vector of classifier parameters to a threshold; and determining 608 an estimate of a count of vectors satisfying the condition in the corpus of vectors based on a weighted count of the identified vectors in the sample. For example, the technique 600 may be implemented using the computing machine 500 of FIG. 5.

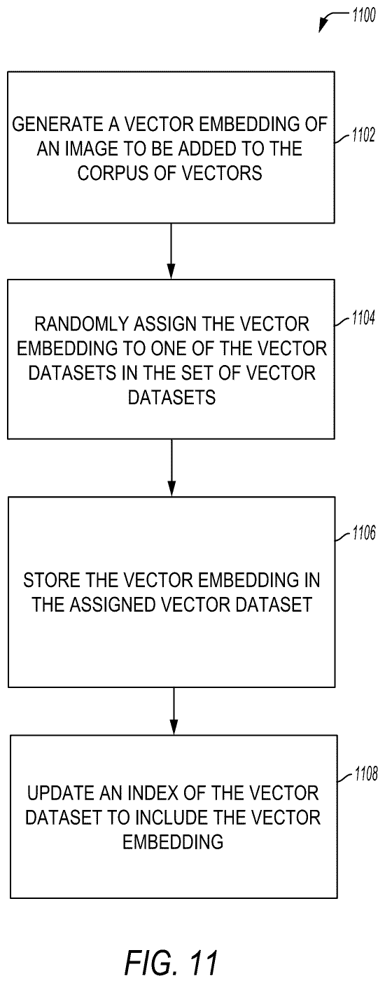

The technique 600 includes accessing 602 a set of vector databases that collectively store a partition of a corpus of vectors into vector databases (e.g., Qdrant, Pinecone, Databricks vector search databases) of different sizes. The corpus of vectors may be ordered based on an inner product of a vector from the corpus of vectors with a vector of classifier parameters. For example, vectors in the corpus of vectors may be embeddings of images. For example, vectors in the corpus of vectors may be embeddings of audio signals. For example, vectors in the corpus of vectors may be embeddings of text (e.g., words or tokens). In some implementations, the vector of classifier parameters is used to implement a binary classifier. For example, the vector of classifier parameters may be a logistic regression model. In some implementations, vectors in the corpus of vectors have been randomly or pseudo-randomly assigned to vector databases in the set of vector databases to implement the partition of the corpus of vectors. For example, the vector databases may be indexed (e.g., using locality sensitive hashing, clustering-based, HNSW indexing) to enable efficient nearest neighbor search within each database of the partition using a vector of classifier parameters to be evaluated to quickly find extrema (e.g., vectors with the largest or smallest values of w.x) within each database of the partition. For example, new vectors may be added to the corpus of vectors using the technique 1100 of FIG. 11. For example, the set of vector databases may be accessed 602 via the bus 508 and/or using the network interface device 520.

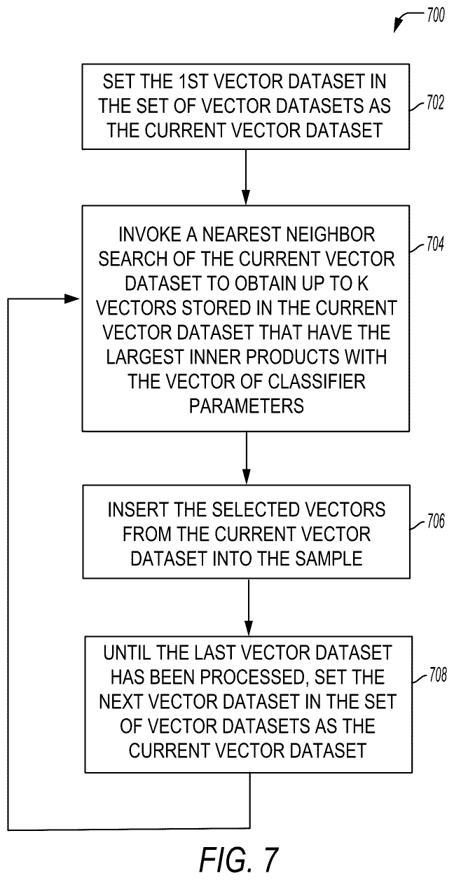

The technique 600 includes selecting 604 up to K vectors from each of the vector databases in the set of vector databases to form a sample of the corpus of vectors. The selected vectors are selected from one end of the order based on the inner product within their respective vector database (e.g., the K largest values of w·x or the K smallest values of w·x). K is an integer. For example, K may be a hyperparameter of an algorithm for sampling and estimating statistics of the corpus of vectors. For example, the algorithms for sum estimation described above, including Equations 1-3, may be used to select 604 vectors to form the sample. In some implementations, selecting 604 vectors from the vector databases in the set of vector databases to form a sample includes invoking a nearest neighbor search of the one of the vector databases to obtain up to K vectors stored in the vector database that have the largest inner products with the vector of classifier parameters. For example, selecting 604 vectors from the vector databases may include implementing the technique 700 of FIG. 7.

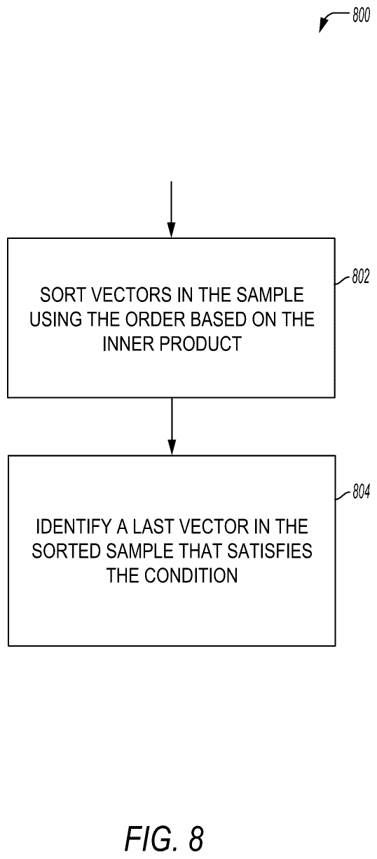

The technique 600 includes identifying 606 vectors in the sample satisfying a condition (e.g., Pr(y=1|x)>0.75 or Pr(y=1|x)<0.25) that compares an inner product of a vector from the corpus of vectors with a vector of classifier parameters to a threshold. For example, the threshold may correspond to a classification probability estimate determined by using the vector of classifier parameters. In some implementations, identifying 606 vectors in the sample satisfying the condition includes sorting the vectors in the sample using the order based on the inner product, and identifying a last vector in the sorted sample that satisfies the condition. For example, identifying 606 vectors in the sample satisfying the condition may include implementing the technique 800 of FIG. 8.

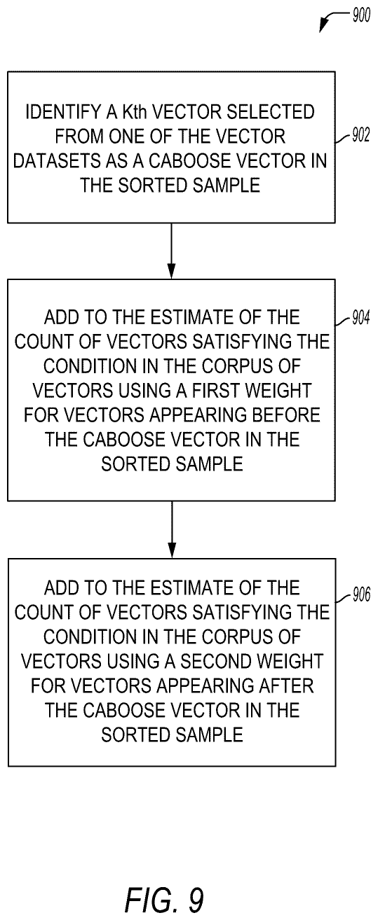

The technique 600 includes determining 608 an estimate of a count of vectors satisfying the condition in the corpus of vectors based on a weighted count of the identified vectors in the sample. In some implementations, determining 608 the estimate of the count of vectors satisfying the condition includes identifying a Kth vector selected from a vector database, which may be referred to as a caboose vector, and updating weights for the weighted count based on the positions of the identified caboose vectors in the sorted sample. For example, the algorithms for sum estimation described above, including Equations 1-3, may be used to determine 608 the estimate of the count of vectors satisfying the condition. For example, determining 608 the estimate of the count of vectors satisfying the condition may include implementing the technique 900 of FIG. 9.

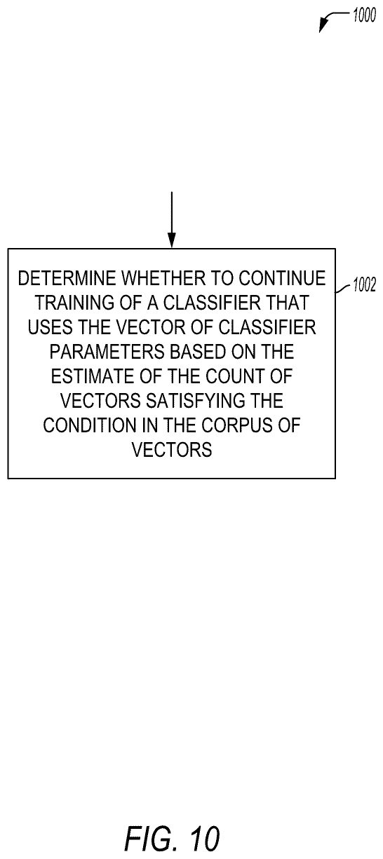

Once the estimate of the count of vectors satisfying the condition in the corpus of vectors has been determined 608, it may be used for various purposes. For example, the estimate may be used evaluate the performance and training quality of the classifier that uses the vector of classifier parameters. For example, the estimate may be used with other estimates to construct an approximation of a cumulative distribution function of the classifier predictions. In some implementations, the technique 600 may be augmented to include determining whether and how to deploy the classifier and/or whether to continue training of a classifier that uses the vector of classifier parameters based on the estimate of the count of vectors satisfying the condition in the corpus of vectors. For example, the technique 600 may include implementing the technique 1000 of FIG. 10.

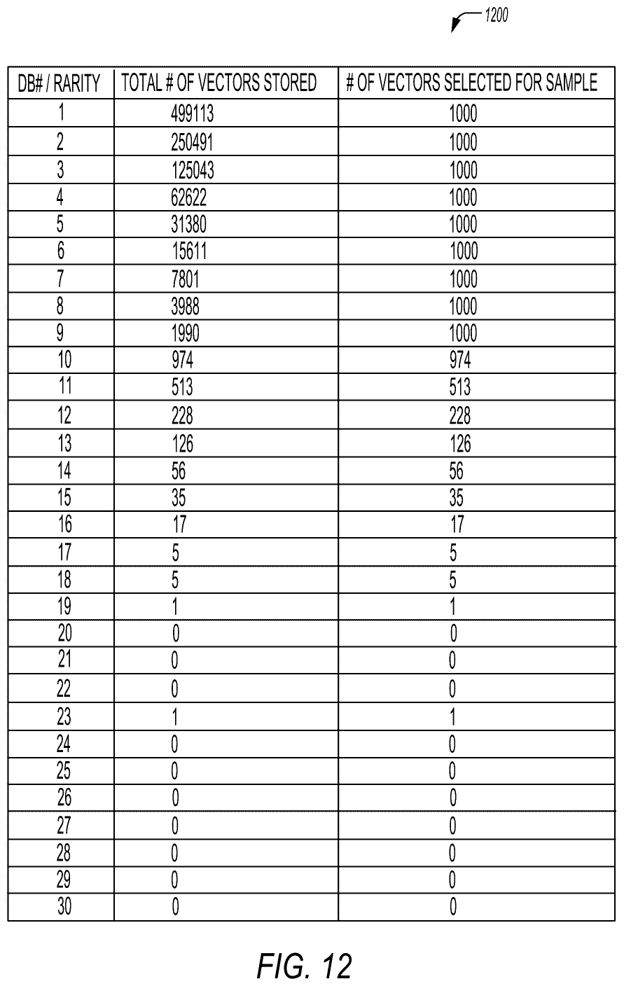

FIG. 7 is a flowchart of an example of a technique 700 for selecting up to K vectors from each vector database in a set of vector databases of different sizes storing a partition of a corpus of vectors to form a sample of the corpus of vectors, in accordance with some embodiments. The technique 700 includes setting 702 the first vector database in the set of vector databases as the current vector database; invoking 704 a nearest neighbor search of the one of the vector databases to obtain up to K vectors stored in the vector database that have the largest inner products with the vector of classifier parameters; inserting 706 the selected vectors from the current vector database into the sample; and, until the last vector database has been processed, setting 708 the next vector database in the set of vector databases as the current vector database and continuing the selection process for the sample. Note that less than K vectors may be selected for a vector database that stores less than K vectors. For example, see the example of vector sampling illustrated in FIG. 12. For example, the technique 700 may be implemented using the computing machine 500 of FIG. 5.

FIG. 8 is a flowchart of an example of a technique 800 for identifying vectors in a sample satisfying a condition, in accordance with some embodiments. The technique 800 includes sorting 802 the vectors in the sample using the order based on the inner product; and identifying 804 a last vector in the sorted sample that satisfies the condition. For example, the technique 800 may be implemented using the computing machine 500 of FIG. 5.

FIG. 9 is a flowchart of an example of a technique 900 for determining an estimate of a count of vectors satisfying a condition in a corpus of vectors, in accordance with some embodiments. The technique 900 includes identifying 902 a Kth vector selected from one of the vector databases as a caboose vector in the sorted sample; adding 904 to the estimate of the count of vectors satisfying the condition in the corpus of vectors using a first weight for vectors appearing before the caboose vector in the sorted sample; and adding 906 to the estimate of the count of vectors satisfying the condition in the corpus of vectors using a second weight for vectors appearing after the caboose vector in the sorted sample, wherein the second weight is greater than the first weight. In some implementations, the second weight is inversely proportional to a probability of assignment of vectors to a subset of the set of vector databases, wherein the subset does not include the vector database that stores the caboose vector. The technique 900 may be repeated for each caboose vector occurring in the set of vector databases. For example, in the scenario illustrated in FIG. 12, the largest nine vector databases return K=1000 vectors for inclusion in the sample (i.e., their sample contribution hits the enforced limit K), so there are nine caboose vectors. In this example, the weights used for determining the estimate of the count of vectors satisfying the condition in the corpus of vectors may be updated nine times as the sorted sample is sequentially processed and caboose vectors are passed. In other words, as vectors in the sample are evaluated in the sequential order, the number of unsaturated vector datasets in the processed portion of the sample decreases when one of the caboose vectors is processed, so subsequent vectors of the sample in the order may be processed using a new weight based on the new, smaller subset of the vector datasets that are unsaturated. Thus, ten different weights may be used in the determination of the estimate in this example. For example, the technique 900 may be implemented as part of the algorithms for sum estimation described above, including Equations 1-3. For example, the technique 900 may be implemented using the computing machine 500 of FIG. 5.

A relatively simple numerical may help to illustrate a process for determining an estimate of a count of vectors satisfying a condition in a corpus of vectors that includes the use of the technique 900. Suppose a corpus of vectors has been partitioned into 5 vector datasets: DS1, DS2, DS3, DS4, and DS5 with respective probabilities of assignment of 1/2, 1/4, 1/8, 1/16 and 1/16. Note that, because a finite number of vector datasets are used, the last two vector datasets DS4 and DS5, are given the same lowest probability of assignment, so that the total probability of assignment across the vector datasets is normalized to one. Further suppose that the hyperparameter K is set to 5 and a sample selected from the corpus at step 604 includes the following vectors from the ordered corpus, where a lower subscript indicates a higher value of the ordering function, ƒ, (e.g., an inner product with a vector of classifier parameters):
DS1: x_1, x_2, x_3, x_4, x_6
DS2: x_5, x_10, x_13
DS3: x_8
DS4:
DS5:
   Note that x_7, x_9, x_11, and x_12 do not appear in the sample, because they have been assigned to DS1, which has a saturated contribution to the sample (i.e., it has contributed K=5 vectors before x_7 in the order). Note also that DS4 and DS5 contributed no vectors to the sample because they happen to be empty, having had no vectors randomly assigned to them. The vectors returned from the three vector datasets are combined and sorted 802 according to the order (i.e., 1 to 13) and the vector x_10 is identified 804 as the last vector in the sample that satisfies the condition. The x_6 vector is identified 902 as a caboose vector for DS1. To calculate the count, the vectors in the sample that satisfy the condition are processed in order, starting with x_1 and starting with an initial weight of 1. Vectors x_1 through x_6 are processed added into the estimated count with weight 1 to arrive at an intermediate result of C=6. After x_6 is processed the weight is changed, because x_6 is a caboose vector. The set of unsaturated vector datasets has been reduced from {DS1, DS2, DS3, DS4, DS5} to {DS2, DS3, DS4, DS5}. The new weight may be inversely proportional to the probability of assignment to {DS2, DS3, DS4 ,DS5}. For example, the second weight used in determining the estimated count may be 1/((1/4)+(1/8)+(1/16)+(1/16))=2. The processing of vectors from the sample continues with x_8 using the 2^{nd} weight of 2. Next, the processing of vectors from the sample continues with x_10 using the 2^{nd} weight of 2, which ends the calculation of the estimated count, because x_10 is the last vector in the sample satisfying the condition. The final estimated count comes to 6+2*(2)=10. Note that the true count is somewhere between 10 and 12, since x_10 satisfies the condition and x_13 does not, but we don't know the exact count because x_11 and x_12 did not appear in our sample to be checked against the condition. In some implementations, additional vector datasets (e.g., DS6, DS7, etc.) may be used with geometrically decreasing probabilities of assignment, most or all of which may end up being empty and contributing no vectors to the sample.

FIG. 10 is a flowchart of an example of a technique 1000 for determining whether to continue training classifier based on an estimate from an evaluation of the classifier, in accordance with some embodiments. The technique 1000 includes determining 1002 whether to continue training of a classifier that uses the vector of classifier parameters based on the estimate of the count of vectors satisfying the condition in the corpus of vectors. For example, if the estimate (possibly in combination with other estimates corresponding to other probability thresholds) indicates that most of the predictions from the classifier for vectors in the corpus of vectors have a high confidence level (e.g., >75% or <25%), then further expensive training or other recalibration processes may be unnecessary and can be avoided. For example, if the estimate indicates that many of the predictions from the classifier for vectors in the corpus of vectors have a low confidence level (e.g., between 75% and 25%), then additional training or recalibration of the classifier may be warranted. In some implementations, a training processes may be continued with more iterations and/or additional training data. For example, the technique 1000 may be implemented using the computing machine 500 of FIG. 5.

FIG. 11 is a flowchart of an example of a technique 1100 for adding new vectors to a corpus of vectors in a manner that randomly or pseudo-randomly partitions the corpus of vectors into a set of vector databases, in accordance with some embodiments. The technique 1100 includes generating 1102 a vector embedding of an image to be added to the corpus of vectors; randomly or pseudo-randomly assigning 1104 the vector embedding to one of the vector databases in the set of vector databases; storing 1106 the vector embedding in the assigned vector database; and updating 1108 an index of the vector database to cover the vector embedding. For example, the index of the vector database may be a hierarchical navigable small world (HNSW) index. For example, the index of the vector database may be a locality sensitive hashing index. For example, the index of the vector database may be a clustering-based index. In some implementations, randomly assigning the vector embedding to one of the vector databases in the set of vector databases comprises drawing an integer from a geometric distribution. In some implementations, randomly assigning the vector embedding to one of the vector databases in the set of vector databases comprises using a pseudo-random number generator. For example, the technique 1100 may be implemented using the computing machine 500 of FIG. 5.

FIG. 12 illustrates an example of sampling a set of vector databases 1200 storing a partition of a corpus of vectors into vector databases of different sizes. In this example, a corpus of 1 million vectors randomly (or pseudo-randomly) partitioned for storage across 30 vector databases corresponding to each row of the chart shown in FIG. 12. Each database corresponds to an integer, which may be referred to as its rarity, that is listed in the first column. The second column lists the actual size (in number of vectors stored) of each vector database that resulted from randomly drawing rarity numbers for each vector as it was added to the corpus of vectors. The higher in the rarity for a vector database, the lower the probability that vectors will be assigned to it for storage and thus the smaller. In this example, the rarity number for each vector are drawn from a geometric distribution with p=0.5, so that each successive vector data base is half as likely to receive a new vector as the previous vector database. The third column list the number of vectors that are selected for sampling when determining an estimate of a count of vectors in the corpus of vectors satisfying a condition (e.g., Pr(y=1|x)>0.75). In this example, up to 1000 of the extreme (e.g., largest w·x) vectors were selected for sampling from each vector database, where 1000 was a hyperparameter of the sampling and estimation algorithm used. These samples from each vector database may then be merged and sorted to estimate the count satisfying the condition for the whole corpus of vectors. Note that vector databases with less than 1000 entries return less than 1000 entries for inclusion in the merged sample.

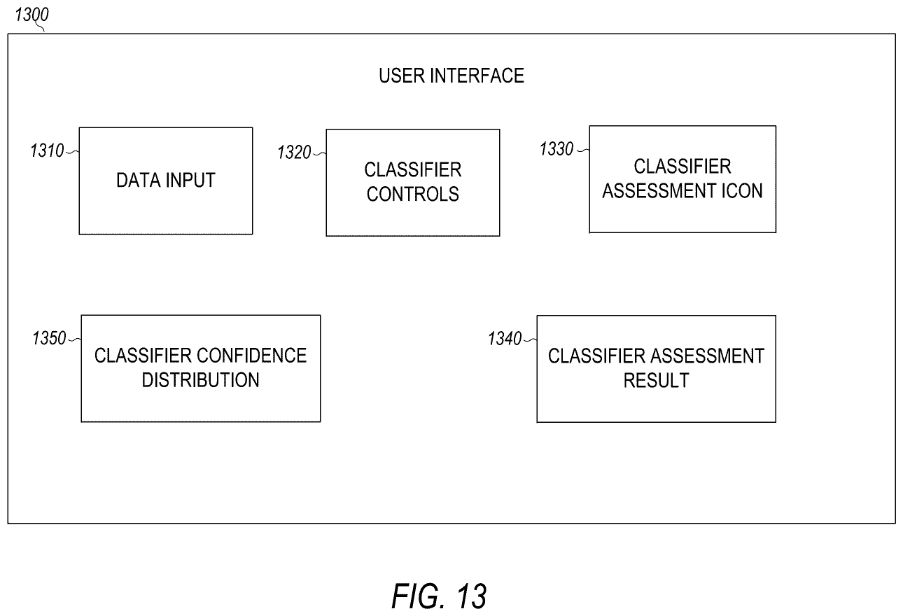

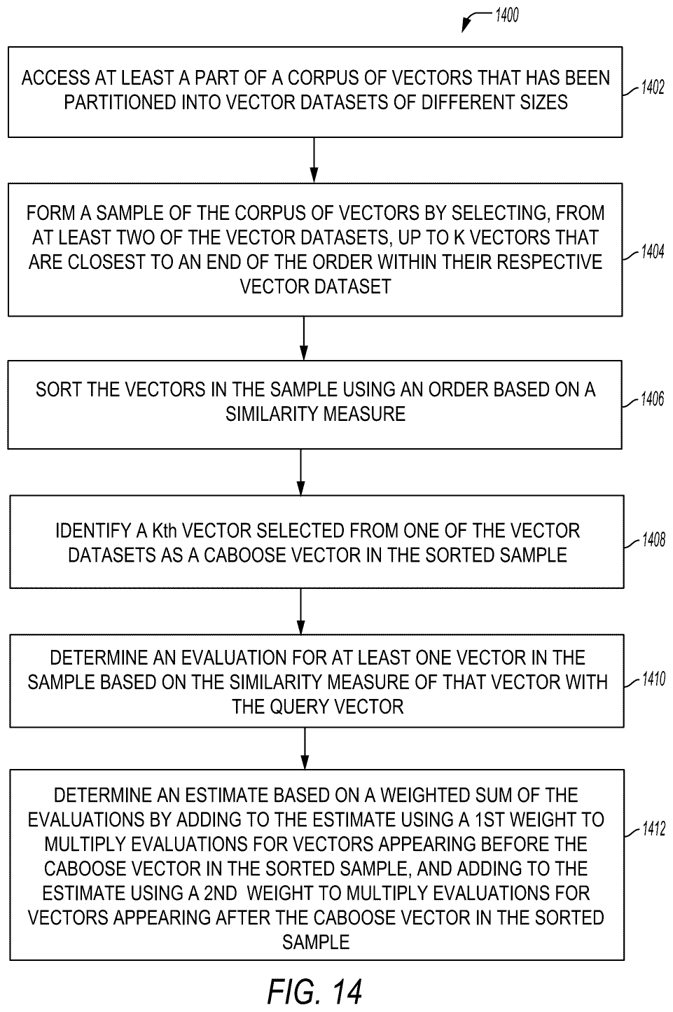

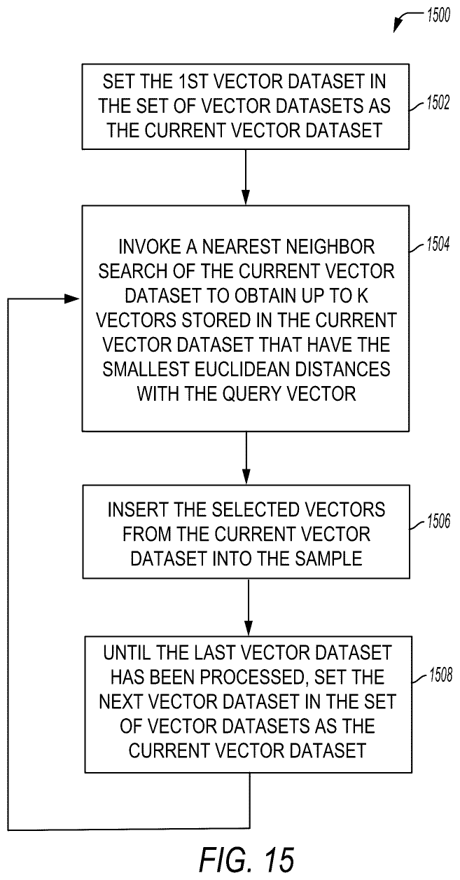

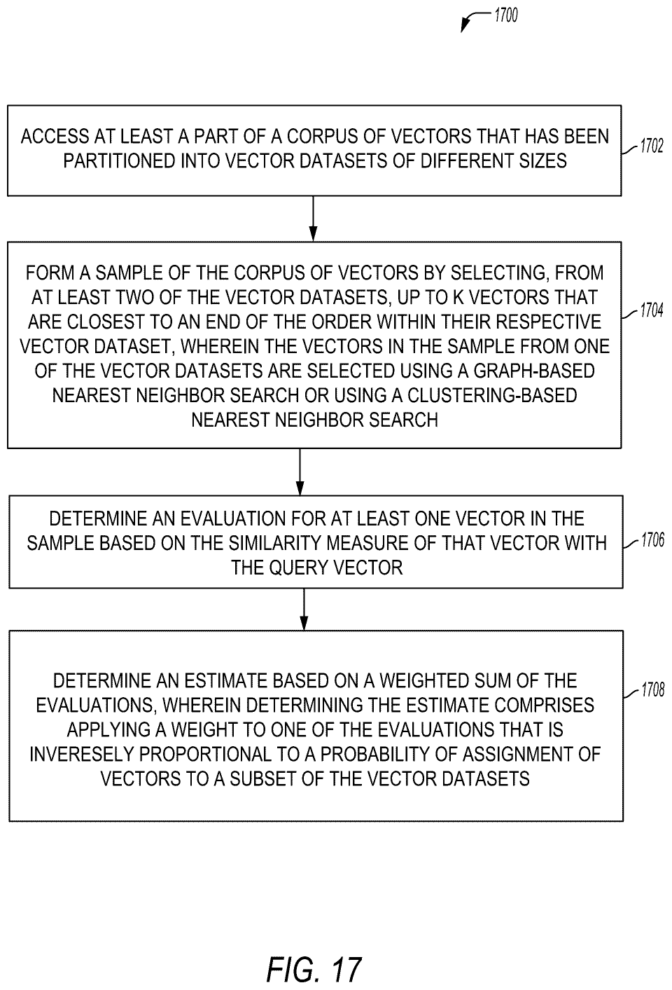

FIG. 13 illustrates an example of a user interface 1300 for classifier evaluation using sum estimation, in accordance with some embodiments. The user interface 1300 includes a data input interface 1310 configured to accept new data for inclusion in the corpus vectors (e.g., using the technique 1100 of FIG. 11); a classifier controls interface 1320 configured to enable the control of updates to classifier parameters (e.g., by initiating one or more iterations of a training process); a classifier assessment icon 1330 configured to enable a user to initiate a classifier assessment operation (e.g., by using the technique 600 of FIG. 6, the technique 1400 of FIG. 14, and/or the technique 1700 of FIG. 17); a classifier assessment result window 1340; and a classifier confidence distribution window 1350. In some implementations, the technique 1500 of FIG. 15 is used to present an assessment of a classifier based on one or more estimates in the classifier assessment result window 1340. For example, the classifier assessment result window 1340 may be used to display one or more indications of classifier quality, such as one or more numbers and or color coding (e.g., green for pass or red for fail) based on thresholding applied to the estimate. In some implementations, the technique 1500 of FIG. 15 is used to present a plot of a classifier confidence distribution based on one or more estimates in the classifier confidence distribution window 1350. For example, the user interface 1300 may be displayed using the video display 510. For example, the user interface 1300 may accept input via the alpha-numeric input device 512 and/or the user interface navigation device 514.

FIG. 14 is a flowchart of an example of a technique 1400 for sum estimation, in accordance with some embodiments. The technique 1400 includes accessing 1402 at least a part of a corpus of vectors that has been partitioned into vector datasets of different sizes, wherein the corpus of vectors has an order based on a similarity measure of a vector from the corpus of vectors with a query vector; forming a sample of the corpus of vectors by selecting 1404, from at least two of the vector datasets, up to K vectors that are closest to an end of the order within their respective vector dataset; sorting 1406 the vectors in the sample using the order based on the similarity measure; identifying 1408 a Kth vector selected from one of the vector datasets as a caboose vector in the sorted sample; determining 1410 an evaluation for at least one vector in the sample based on the similarity measure of that vector with the query vector; and determining 1412 an estimate based on a weighted sum of the evaluations by adding to the estimate using a first weight to multiply evaluations for vectors appearing before the caboose vector in the sorted sample, and adding to the estimate using a second weight to multiply evaluations for vectors appearing after the caboose vector in the sorted sample, wherein the second weight is greater than the first weight. For example, the technique 1400 may be used to implement the Algorithm 1, described with pseudo code below. For example, the technique 1400 may be implemented using the computing machine 500 of FIG. 5.

The technique 1400 includes accessing 1402 at least a part of a corpus of vectors that has been partitioned into vector datasets (e.g., datasets stored in Qdrant, Pinecone, and/or Databricks vector search databases) of different sizes. The corpus of vectors has an order based on a similarity measure of a vector from the corpus of vectors with a query vector (e.g., a vector of classifier parameters, a vector selected from the dataset itself, or any external vector with the same dimensions as the vectors in the dataset). For example, the similarity measure may be an inner product. For example, the similarity measure may be a Euclidean distance. For example, the similarity measure may be a cosine similarity. For example, vectors in the corpus of vectors may be embeddings of images. For example, vectors in the corpus of vectors may be embeddings of audio signals. For example, vectors in the corpus of vectors may be embeddings of text (e.g., words or tokens). In some implementations, the query vector is used to implement a binary classifier. For example, the query vector may be a logistic regression model. In some implementations, vectors in the corpus of vectors have been randomly or pseudo-randomly assigned to individual vector datasets from amongst the vector datasets to implement the partition of the corpus of vectors. For example, the vector databases may be indexed to enable efficient nearest neighbor search within each database of the partition using a query vector to be evaluated to quickly find extrema (e.g., vectors with the largest or smallest values of w·x) within each database of the partition. In some implementations, the vector datasets are respectively stored in vector databases that are indexed for accelerated nearest neighbor search using a graph-based nearest neighbor search or using a clustering-based nearest neighbor search. For example, new vectors may be added to the corpus of vectors using the technique 1100 of FIG. 11. For example, the set of vector datasets may be accessed 1402 via the bus 508 and/or using the network interface device 520.

The technique 1400 includes forming a sample of the corpus of vectors by selecting 1404, from at least two of the vector datasets, up to K vectors that are closest to an end of the order within their respective vector dataset. The selected vectors are selected from one end of the order based on the similarity measure (e.g., an inner product or a Euclidean distance) within their respective vector database (e.g., the K largest values of w·x or the K smallest values of w·x). K is an integer. For example, K may be a hyperparameter of an algorithm for sampling and estimating statistics of the corpus of vectors. For example, the algorithms for sum estimation described above, including Equations 1-3, may be used to select 1404 vectors to form the sample. In some implementations, selecting 1404 up to K vectors from one of the vector datasets to form the sample includes invoking a nearest neighbor search of the one of the vector datasets to obtain up to K vectors stored in the vector dataset that have the largest inner products with the query vector. For example, selecting 1404 vectors from the vector datasets may include implementing the technique 700 of FIG. 7. In some implementations, selecting 1404 up to K vectors from one of the vector datasets to form the sample includes invoking a nearest neighbor search of the one of the vector datasets to obtain up to K vectors stored in the vector dataset that have the smallest Euclidean distances with the query vector. For example, selecting 1404 vectors from the vector datasets may include implementing the technique 1500 of FIG. 15.

The technique 1400 includes sorting 1406 the vectors in the sample using the order based on the similarity measure. For example, the similarity measure may be a Euclidean distance and the vectors in the sample may be sorted based on their distance from the query vector. For example, the similarity measure may be an inner product and the vectors in the sample may be sorted based on their inner product with the query vector.

The technique 1400 includes identifying 1408 a Kth vector selected from one of the vector datasets as a caboose vector in the sorted sample. As vectors in the sample are processed in sorted order to determine 1412 an estimate, once this caboose vector has been processed in the sample, the contribution from that one of the vector datasets will have been exhausted and the weights used for determining 1412 the estimate may be updated accordingly (e.g., as described below).

The technique 1400 includes determining 1410 an evaluation for at least one vector in the sample (e.g., for each vector in the sample) based on the similarity measure of that vector with the query vector (e.g., a vector of classifier parameters). For example, the similarity measure may be an inner product. In some implementations, the evaluation for at least one vector in the sample is determined 1410 as an exponential function of the inner product of that vector with the query vector. For example, the sample may be used for estimating softmax function. In some implementations, the evaluation for at least one vector in the sample is determined 1410 as a sigmoid function of the inner product of that vector with the query vector. For example, the sample may be used for estimating an expected number of positives for logistic regression. For example, the similarity measure may be a Euclidean distance. In some implementations, the evaluation for at least one vector in the sample is determined 1410 as a Gaussian function of the Euclidean distance of that vector with the query vector. For example, the sample may be used for KDE.

The technique 1400 includes determining 1412 an estimate based on a weighted sum of the evaluations by adding to the estimate using a first weight to multiply evaluations for vectors appearing before the caboose vector in the sorted sample, and adding to the estimate using a second weight to multiply evaluations for vectors appearing after the caboose vector in the sorted sample, wherein the second weight is greater than the first weight. In some implementations, the second weight is inversely proportional to a probability of assignment of vectors to a subset of the set of vector datasets, wherein the subset does not include the vector dataset that stores the caboose vector. The step 1412 may be repeated for each caboose vector occurring in the set of vector databases. For example, in the scenario illustrated in FIG. 12, the largest nine vector databases return K=1000 vectors for inclusion in the sample (i.e., their sample contribution hits the enforced limit K), so there are nine caboose vectors. In this example, the weights used for determining the estimate for the corpus of vectors may be updated nine times as the sorted sample is sequentially processed and caboose vectors are passed. Thus, ten different weights may be used in the determination of the estimate in this example. For example, step 1412 may be implemented as part of the algorithms for sum estimation described above, including Equations 1-3.

Once the estimate for the corpus of vectors has been determined 1412, it may be used for various purposes. For example, the estimate may be used evaluate the performance and training quality of the classifier that uses the query vector as a vector of classifier parameters. For example, the estimate may be used with other estimates to construct an approximation of a probability density function of the classifier predictions. In some implementations, the technique 1400 may be augmented to include determining, based on the estimate, whether and how to deploy the classifier and/or whether to continue training of a classifier that uses the query vector as a vector of classifier parameters. For example, the technique 1400 may include implementing the technique 1000 of FIG. 10. For example, the technique 1400 may include implementing the technique 1500 of FIG. 15.

FIG. 15 is a flowchart of an example of a technique 1500 for selecting up to K vectors from each vector dataset in a set of vector datasets of different sizes storing a partition of a corpus of vectors to form a sample of the corpus of vectors, in accordance with some embodiments. For example, each vector dataset may be stored in a vector database (e.g., in Qdrant, Pinecone, and/or Databricks vector search databases). The technique 1500 includes setting 1502 the first vector dataset in the set of vector datasets as the current vector dataset; invoking 1504 a nearest neighbor search of the one of the vector datasets to obtain up to K vectors stored in the vector dataset that have the smallest Euclidean distances with the query vector; inserting 1506 the selected vectors from the current vector dataset into the sample; and, until the last vector dataset has been processed, setting 1508 the next vector dataset in the set of vector datasets as the current vector dataset and continuing the selection process for the sample. Note that less than K vectors may be selected for a vector database that stores less than K vectors. For example, see the example of vector sampling illustrated in FIG. 12. For example, the technique 1500 may be implemented using the computing machine 500 of FIG. 5.

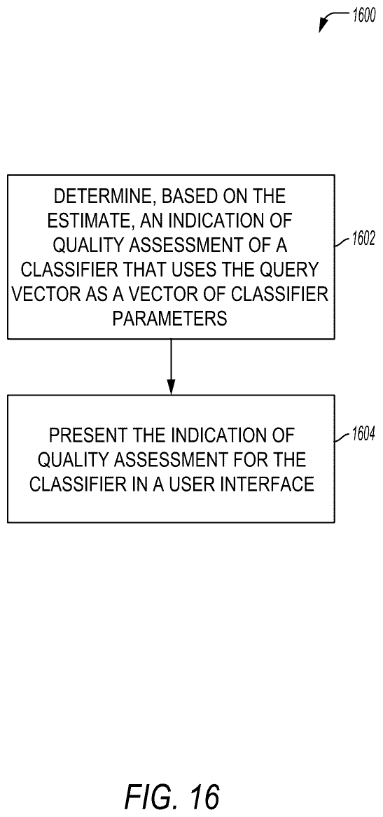

FIG. 16 is a flowchart of an example of a technique 1600 for presenting an indication of quality assessment for a classifier, in accordance with some embodiments. The technique 1600 includes determining 1602, based on the estimate, an indication of quality assessment of a classifier that uses the query vector as a vector of classifier parameters; and presenting 1604 the indication of quality assessment for the classifier in a user interface. For example, the technique 1600 may be implemented using the computing machine 500 of FIG. 5. For example, the indication of quality assessment for the classifier may be presented 1604 in a user interface displayed on the video display 510.

FIG. 17 is a flowchart of an example of a technique 1700 for classifier evaluation using sum estimation, in accordance with some embodiments. The technique 1700 includes accessing 1702 at least a part of a corpus of vectors that has been partitioned into vector datasets of different sizes; forming a sample of the corpus of vectors by selecting 1704, from at least two of the vector datasets, up to K vectors that are closest to an end of the order within their respective vector dataset; determining 1706 an evaluation for at least one vector in the sample based on the similarity measure of that vector with the query vector; and determining 1708 an estimate based on a weighted sum of the evaluations. Determining 1708 the estimate may include applying a weight to one of the evaluations that is inversely proportional to a probability of assignment of vectors to a subset of the vector datasets. The vectors of the sample from one of the vector datasets may be selected using a graph-based nearest neighbor search or using a clustering-based nearest neighbor search. For example, the technique 1700 may be implemented using the computing machine 500 of FIG. 5.

The technique 1700 includes accessing 1702 at least a part of a corpus of vectors that has been partitioned into vector datasets (e.g., datasets stored in Qdrant, Pinecone, and/or Databricks vector search databases) of different sizes. The corpus of vectors has an order based on a similarity measure of a vector from the corpus of vectors with a query vector (e.g., a vector of classifier parameters). For example, the similarity measure may be an inner product. For example, the similarity measure may be a Euclidean distance. For example, the similarity measure may be a cosine similarity. For example, vectors in the corpus of vectors may be embeddings of images. For example, vectors in the corpus of vectors may be embeddings of audio signals. For example, vectors in the corpus of vectors may be embeddings of text (e.g., words or tokens). In some implementations, the query vector is used to implement a binary classifier. For example, the query vector may be a logistic regression model. In some implementations, vectors in the corpus of vectors have been randomly or pseudo-randomly assigned to individual vector datasets from amongst the vector datasets to implement the partition of the corpus of vectors. For example, the vector databases may be indexed to enable efficient nearest neighbor search within each database of the partition using a query vector to be evaluated to quickly find extrema (e.g., vectors with the largest or smallest values of w·x) within each database of the partition. In some implementations, the vector datasets are respectively stored in vector databases that are indexed for accelerated nearest neighbor search using a graph-based nearest neighbor search or using a clustering-based nearest neighbor search. For example, new vectors may be added to the corpus of vectors using the technique 1100 of FIG. 11. For example, the set of vector datasets may be accessed 1702 via the bus 508 and/or using the network interface device 520.

The technique 1700 includes forming a sample of the corpus of vectors by selecting 1704, from at least two of the vector datasets, up to K vectors that are closest to an end of the order within their respective vector dataset. The vectors of the sample from one of the vector datasets may be selected 1704 using a graph-based nearest neighbor search or using a clustering-based nearest neighbor search. The selected vectors are selected 1704 from one end of the order based on the similarity measure (e.g., an inner product or a Euclidean distance) within their respective vector database (e.g., the K largest values of w·x or the K smallest values of w·x). K is an integer. For example, K may be a hyperparameter of an algorithm for sampling and estimating statistics of the corpus of vectors. For example, the algorithms for sum estimation described above, including Equations 1-3, may be used to select 1704 vectors to form the sample. In some implementations, selecting 1704 up to K vectors from one of the vector datasets to form the sample includes invoking a nearest neighbor search of the one of the vector datasets to obtain up to K vectors stored in the vector dataset that have the largest inner products with the query vector. For example, selecting 1704 vectors from the vector datasets may include implementing the technique 700 of FIG. 7. In some implementations, selecting 1704 up to K vectors from one of the vector datasets to form the sample includes invoking a nearest neighbor search of the one of the vector datasets to obtain up to K vectors stored in the vector dataset that have the smallest Euclidean distances with the query vector. For example, selecting 1704 vectors from the vector datasets may include implementing the technique 1500 of FIG. 15.

The technique 1700 includes determining 1706 an evaluation for at least one vector in the sample based on the similarity measure of that vector with the query vector. For example, the similarity measure may be an inner product. In some implementations, the evaluation for at least one vector in the sample is determined 1706 as an exponential function of the inner product of that vector with the query vector. For example, the sample may be used for estimating a softmax function. In some implementations, the evaluation for at least one vector in the sample is determined 1706 as a sigmoid function of the inner product of that vector with the query vector. For example, the sample may be used for estimating an expected number of positives for logistic regression. For example, the similarity measure may be a Euclidean distance. In some implementations, the evaluation for at least one vector in the sample is determined 1706 as a Gaussian function of the Euclidean distance of that vector with the query vector. For example, the sample may be used for KDE.

The technique 1700 includes determining 1708 an estimate based on a weighted sum of the evaluations. Determining 1708 the estimate includes applying a weight to one of the evaluations that is inversely proportional to a probability of assignment of vectors to a subset of the vector datasets. For example, step 1708 may be implemented as part of the algorithms for sum estimation described above, including Equations 1-3.

Once the estimate for the corpus of vectors has been determined 1708, it may be used for various purposes. For example, the estimate may be used evaluate the performance and training quality of a classifier that uses the query vector as a vector of classifier parameters. For example, the estimate may be used with other estimates to construct an approximation of a probability density function of the classifier predictions. In some implementations, the technique 1700 may be augmented to include determining, based on the estimate, whether and how to deploy the classifier and/or whether to continue training of a classifier that uses the query vector as a vector of classifier parameters. For example, the technique 1700 may include implementing the technique 1000 of FIG. 10. For example, the technique 1700 may include implementing the technique 1500 of FIG. 15.

```
Algorithm 1 Fast Estimate
Input: Union of top k elements at every level: U, func-
tion to be estimated ƒ_{q}
∀ [symbol] : count [symbol]  = 0
p = 1
E = 0
for x in U, sorted by decreasing ƒ_{q} value do
  E ← E + ƒ_{q} (x)/p
  count [symbol] ₍ₓ₎ ← count [symbol] ₍ₓ₎ + 1
  if count [symbol] ₍ₓ₎ = k then
    p ← p − 2⁻ [symbol] ^{(x)}
  end if
end for
return E
```

Over the past decade, machine learning systems have increasingly leveraged semantic embeddings for objects such as words and tokens, sentences and documents, images, audio clips, videos, and a variety of other objects. Correspondingly, given the importance of retrieval of semantically related objects, there has been significant advances in algorithms for nearest neighbor search including locality sensitive hashing (LSH), clustering-based search, and hierarchical navigable small-world graphs (HNSW).

Owing to the utility and effectiveness of nearest neighbor search systems, there exist a variety of commercial solutions, typically based on HNSW, and to a lesser extent, clustering-based search. Systems and techniques are described herein for a set of problems that involve computing or estimating a sum over all elements in a large dataset. Examples of such a task include kernel-density estimation (KDE) and computing probabilities for log-linear models. While there are estimators with provable guarantees based on locality-sensitive hashing, these methods lack practical implementations and do not make use of techniques such as HNSW.

Described herein are systems and methods which can use any maximization oracle and have a significantly better size dependence, of O(log n), than conventional approaches. Access to a maximization oracle may be used. Given a non-negative function ƒ(·, ·) (e.g., the exponentiation of the negative squared Euclidean distance for KDE with Gaussian kernel) and a dataset

$${\{ {x}_{i} \}}_{i = 1}^{n} ,$$

the oracle builds a data-structure that allows it to quickly compute the top object argmax_{i∈[n]}ƒ(xᵢ,q) based on a query q, and more generally, the top-k objects. Given such an oracle, some implementations yield a provable estimate of Σ_{i∈[n]}ƒ(xᵢ,q) using O(log n) retrieved elements from the maximization oracle. For example, each data point may be assigned to one of multiple “levels” with exponentially decaying probabilities

$$( e . g . {,}^{\frac{1}{2} , \frac{1}{4} , \frac{1}{8} , …} ) ,$$

as may be done for skip-lists and HNSW, and then build a maximization oracle data-structure for each level. In total, there may be O(log n) levels and a data-structure for each. For example, for a query q, the top-k objects may be retrieved from each level, and an unbiased estimate may be computed using Algorithm 1 (see supra), which may be effective for pairwise summation tasks on large image datasets, using a simulated maximization oracle.

Some implementations may: use an estimator for pairwise summation given the top-k elements from each exponentially-sampled level; use an unbiased estimator with a proven error bound that holds with high probability (with respect to the sampling of the levels); and introduce two additional pairwise summation tasks: counting the number of elements within a ball and computing the expected number of positive labels according to a binary logistic regression model.

### Setting

We assume that we have some set of data elements [symbol] and some space of queries [symbol] . Given a positive function ƒ: [symbol] × [symbol] → [symbol] ₊ and dataset X ⊂ [symbol] of size n, our goal is to estimate Σ_{x∈X} ƒ(x, q) for a given query q ∈ [symbol] . For simplicity, we define ƒ_{q}=ƒ(·, q). We assume access to a maximization oracle that can compute Topₖ(X, ƒ_{q})=argmax_{S⊂X:|S|≤k} Σ_{x∈S} ƒ(x, q) efficiently based on a pre-computed data structure.

A central idea for our work is that each element x ∈ X is randomly assigned a “level” [symbol] (x) and we build a maximization data-structure for each level. If we define X [symbol] (={x ∈ X: [symbol] (x)= [symbol] } as the data elements at level [symbol] , then our maximization oracle can compute Topₖ (X [symbol] , ƒ_{q}) efficiently.

### Method & Analysis

For ease of analysis, we will fix a particular query q, and define xᵢ as the element x ∈ X with the i^{th} largest ƒ(·, q) value, breaking ties randomly. Therefore, x₁=argmax_{x∈X} ƒ(x, q) and xₙ=argmin_{x∈X} ƒ(x, q). For convenience, define ƒᵢ=ƒ(xᵢ, q) and [symbol] ᵢ= [symbol] (xᵢ). Thus, our goal is to estimate

$${\sum }_{i = 1}^{n} {f}_{j}$$

with access to {STopₖ(X [symbol] ,ƒ_{q})} [symbol] . We sample the level for each data point independently as a geometrie random variable with p=1/2, so ∀ [symbol] ∈ [symbol] , Pr( [symbol] (x)= [symbol] )=2⁻ [symbol] . However, how can we use this to estimate the full sum?

### Union of the TopK

The union of the top k elements from each level is:

$$U = {Top}_{k} ( , {f}_{q} ) \qquad ( 4 )$$

$$Note that \vert U \vert = min ( \vert \vert , k ) , so$$

$$𝔼 [ \vert U \vert ] = 𝔼 [ min ( \vert \vert , k ) ] \leq min ( n , k ) .$$

$$Defining *= ⌊ {log}_{2} ( n / k ) ⌋ , then ∀ \leq * : n \geq k and$$

$$∀ > * : n < k .$$

It can thus be seen that [symbol] [|U|]≤( [symbol] ^{*}+2)k= [symbol] (k log n).

### Constructing an Unbiased Estimate

For a given i, what is the probability that xᵢ ∈ U? This probability becomes easy to compute if we condition on { [symbol] ⱼ}_{j<i}. Conditioned on the sampled levels for larger elements, define whether there is still “availability” on level

$$as a ( , i - 1 ) = ( {\sum }_{j = 1}^{i - 1} 1 [ {j}_{} = ] < k ) .$$

Define Iᵢ as the indicator for level [symbol] ᵢ having availability (at i−1) and pᵢ as the probability of [symbol] ᵢ being sampling as a level with availability:

$${I}_{i} = 1 [ a ( {i}_{} , i - 1 ) ] \qquad ( 5 )$$

$${p}_{i} = {Pr}_{{i}_{}} [ a ( {i}_{} , i - 1 ) ] = {\sum }_{: a ( , i - 1 )} \qquad ( 6 )$$

First, we can see that conditioned on { [symbol] ⱼ}_{j<i}, [symbol] [Iᵢ/pᵢ]=1. This motivates us to estimate F=Σᵢƒᵢ with the unbiased estimate,

$$E = {\sum }_{i = 1}^{n} \frac{{I}_{i}}{{p}_{i}} {f}_{i} \qquad ( 7 )$$

Second, note that Iᵢ=1 if and only if xᵢ ∈ U, so there is zero contribution from elements outside of U. Furthermore, perhaps surprisingly, we can compute pᵢ from just the elements of U. In particular, if we iterate through U in order of decreasing ƒ_{q} value, we can decrease pᵢ whenever a level becomes full (no longer available). See Algorithm 1.

### Variance of Estimator

The error of our estimate is E−F=Σᵢ(Iᵢ/pᵢ−1)ƒᵢ. A straightforward calculation shows that each (Iᵢ/pᵢ−1)ƒᵢ conditioned on { [symbol] ⱼ}_{j<i} is mean-zero with variance

$$( 1 / {p}_{i} - 1 ) {f}_{i}^{2} .$$

Since the variance blows up as pᵢ→0, if the levels fill up early while ƒᵢ is large, then pᵢ will be small, yielding high variance.

The expectation of

$${\sum }_{i = 1}^{{2}^{} k} 1 [ {i}_{} = ]$$

is k, so we might expect level [symbol] to be filled (not available) after the first [symbol] k elements. We can show that it is very unlikely for level [symbol] to be filled after [symbol] b elements, for some b<k.

By Chernoff bound for a binomial distribution.

Proposition 3.1. For any level [symbol] , and k and δ such that k≥12 log (1/δ), with b=k−┌\sqrt{3k log (1/δ)}┐, Pr(¬a( [symbol] , [symbol] b))≤δ. (reprove!)

Unfortunately, as there are infinite levels, we cannot union bound over all levels. However, the expected number of points at high levels is decaying exponentially, allowing us to bound their sum with high probability.

Proposition 3.2. For any k and δ such that k≥12 log (1/δ), with b=k−┌\sqrt{3k log (1/δ)}┐, Pr(V [symbol] _{≥} [symbol] _{*3}¬a( [symbol] , 2 [symbol] b)≤δ. (reprove!)

Thus, we can invoke the above two propositions with failure probability δ/( [symbol] ^{*+}3) and union bound:

Corollary 3.3. For any k and δ such that k≥12 log (( [symbol] *+3)/δ), with b=k−┌{square root over (3k log ((*+3)/δ))}┐, Pr(V [symbol] ¬a( [symbol] , 2 [symbol] b))≤δ.

(set as proposition) Conditioned on ∧ [symbol] a( [symbol] , 2 [symbol] b), we can lower bound pᵢ. For i≤2b, ∀ [symbol] : a( [symbol] ,i−1) and thus Pᵢ=1. For i>2b, ∀ [symbol] >=┌log₂(i/b)┐: a( [symbol] , i−1) so pᵢ≥2·2^{-┌log}^{₂}^{(i/b)┐}≥b/i.

(set as proposition) Note that

$$F \geq {\sum }_{j = 1}^{i} {f}_{j} \geq {\sum }_{j = 1}^{i} {f}_{i} \geq {if}_{i} ,$$

and thus ƒᵢ≤F/i. Combining this with the bound on pᵢ, we can see that

$$( 1 / {p}_{i} - 1 ) {f}_{i}^{2} \leq ( F / b ) {f}_{i} .$$

Summing over i, the variance is at most F²/b. We show in the appendix, that in fact, the conditional variance is less than (3/8)F²/b.

### Martingale Version of Bernstein's Inequality

Theorem 3.4. Suppose

$$𝔼 [ {Z}_{i} \vert {ℱ}_{i - 1} ] = 0 and \vert {Z}_{i} \vert < M . \qquad ( 8 )$$

$$Define V = {\sum }_{i = 1}^{n} 𝔼 [ {Z}_{i}^{2} \vert {ℱ}_{i - 1} ] .$$

$$Then ,$$

$$Pr ( \vert {\sum }_{i} {X}_{i} \vert \geq t ) \leq 2 exp ( - \frac{1}{2} \frac{{t}^{2}}{V + Mt / 3} )$$

This implies that with probability 1−δ.

$$\vert {\sum }_{i} {Z}_{i} \vert \leq \sqrt{2 V log ( 2 / δ )} + \frac{2 M}{3} log ( 2 / δ ) \qquad ( 9 )$$

In our case, Zᵢ=(Iᵢ/pᵢ−1) ƒᵢ, so E−F=ΣᵢZᵢ, and the filtration [symbol] ᵢ={ [symbol] ⱼ}_{j≤i}. From earlier results, M=F/b and V=(3/8)F²/b.

Altogether, assuming k≥12 log (2( [symbol] ^{*}+3)/δ), using δ/2 failure probability for ensuring the levels don't fill too fast, and δ/2 failure probability for the Bernstein inequality,

$$\frac{\vert E - F \vert}{F} \leq \sqrt{\frac{3 log ( 4 / δ )}{4 b}} + \frac{2 log ( 4 / δ )}{3 b} \qquad ( 10 )$$

$$with b = k - \sqrt{3 k log ( 2 {ℓ}^{*} + 3 ) / δ )}$$

As an example, for billion-sized datasets where n=10⁹, k=1000, and δ=0.05, then [symbol] ^{*}=19 and 6=857, and thus, with high confidence, the relative error of our estimate is less than 0.0654.

### Correction Term

One may note that our algorithm performs relatively poorly when all {ƒᵢ}ᵢ, are equal, since F=nƒᵢ for any i. Here, we introduce a correction term for c>0:

$$F = {\sum }_{i} {f}_{i} \qquad ( 11 )$$

$$= cn + {\sum }_{i} ( {f}_{i} - c ) \qquad ( 12 )$$

Then we can form an estimate as

$${E}_{c} = cn + {\sum }_{i} \frac{{I}_{i}}{{p}_{i}} ( {f}_{i} - c ) \qquad ( 13 )$$

$$= c ( n - {\sum }_{i} {I}_{i} / {p}_{i} ) + {\sum }_{i} \frac{{I}_{i}}{{p}_{i}} {f}_{i} \qquad ( 14 )$$

$$= c ( n - {\sum }_{i} {I}_{i} / {p}_{i} ) + E \qquad ( 15 )$$

$$If c = \frac{{\sum }_{i = ⌈ n / 2 ⌉}^{n} {f}_{i}}{n - ⌈ n / 2 ⌉} ,$$

then the (sum conditional) variance for E_{c} will be smaller than for E, and the bound M will be twice, 2F/6. Thus, we can get (nearly) the saqme bound but perform well in the special case that all ƒᵢ are equal.

### Experiments

In this section, we present evaluation of a proposed method against baseline methods with multiple problem settings.

### Experimental Settings

### Tasks

1. Count Condition (e.g., count a number of points in a ball, i.e., within a particular distance from a center. This can be written with ƒ(x, q)=1[∥x−q∥₂≤r]. Note that real-world data is not needed, because varying the radius may yield the same function values (M 1's and N-M 0's).) For example, assume a dataset with N data points and define:

$$f ( x , q ) = - x \qquad ( 16 )$$

Now let us setup a counting condition for this dataset with parameter m such that

$$C ( f ( x , q ) , m ) = 1 [ f ( x , q ) >= - m ] \qquad ( 17 )$$

Thus, for given value of m

$$E = {\sum }_{i = 1}^{N} C ( f ( x , q ) , m ) = m \qquad ( 18 )$$

2. CLIP Loss Function (e.g., softmax, partition function for log-linear model, large output spaces, large language models, modeling probabilities over a dataset, or CLIP interpretation.) The s-CLIPLoss is a statistically interpretable quality metric, better than the CLIPScore. The s-CLIPLoss may be defined as:

$$s = CLIPLoss ( {x}_{i}^{υ l} ) := τ / K {\sum }_{k = 1}^{K} {l}_{Bk} ( {x}_{i}^{υ l} \qquad ( 19 )$$

3. Kernel Density Estimation (KDE) (e.g., KDE may be used for outlier detection, clustering, and various density-based data selection methods. A variety of kernels may be used, such as a Gaussian kernel.) KDE is a non-parametric method to estimate the probability density function of a random variable. For an image dataset of size N represented with vectors of dimension d, the KDE at a point x may be defined as:

$$KDE ( x , q ) = 1 / {( 2 * π * {σ}^{2} )}^{d / 2} exp - {‖ q - x ‖}^{2} / 2 {σ}^{2} \qquad ( 20 )$$

Likelihood of query vector q may, thus be defined as 1/|X|Σ_{x∈X} KDE(x,q). This value may be scaled to avoid running into numerical overflow and underflow errors. Let KDE(x′,q) be the maximum value of KDE across all points in this dataset for q. Thus,

$${E}_{scaled} = exp ( - {‖ q - x ‖}^{2} ) - ( - {‖ q - {x}^{′} ‖}^{2} ) / 2 {σ}^{2} \qquad ( 21 )$$

4. Estimation of Positives for Classifiers (e.g., generalized linear models (GLMs) are used widely in statistics and machine learning.) Because of deep learning embeddings, sometimes just need to train last layer (e.g., linear probing), which is logistic regression, an example of GLM. For computing a summary statistic over the datapoints (e.g., number of positive labels), this problem amounts to pairwise summation with the dot product. For an image dataset of size N represented with vectors of dimension d, each image has a true label yₜᵣᵤₑ. We can define ‘classes’ C of images on this dataset as groups of images having the same label. Now, we want to train a Logistic Regression classifier for class c over N images, considering yₜᵣᵤₑ=y′ as positive samples of this class and all other images as negative samples of this class. Over a very large dataset, we sub sample 0.1 N points to speed up training. We can now estimate the probability for each of the N samples belonging to this class, using the weights W_{c} and bias b_{c} parameters of the trained classifier, as

$$f ( x , c ) = 1 / 1 + exp {W}_{c} \dot{x} + {b}_{c} \qquad ( 22 )$$

We can estimate the total number of positive samples as Σx ∈ X′ where X′ ⊂ X, such that probabilities of all in X′ is greater than a chosen threshold. This is roughly estimated by Σx ∈ X′. Thus,

$$E = \sum inXf ( x , c ) = 1 / 1 + exp {W}_{c} \dot{x} + {b}_{c} \qquad ( 23 )$$

### Models

For example, the embeddings used to encode images may be ResNet-50 Embeddings from ILSVRC 2015, which are high-dimensional feature representations extracted from the ResNet-50 architecture, pre-trained with ImageNet. Resnet50 architecture is 50-layer deep convolution neural network that leverages residual connections to enable the efficient training of deep models. With each convolution and pooling layer, the network extract higher-level features. Feature maps are aggregated in a global average pooling layer, which is the penultimate layer of the network and also outputs a 2048-dimensional feature vector for each image. Pre-training using ImageNet allows embeddings to inherit rich, generic visual features. Resnet-50 embeddings compactly capture semantic, spatial and texture information and are highly discriminative and robust to transformations.

For example, the embeddings used to encode images may be OpenAI's CLIP ViTL/14@336px Embeddings, high-dimensional feature representations extracted from the CLIP (Contrastive Language-Image Pre-training) model, specifically the Vision Transformer (ViT) variant with a large architecture (L), 14 attention heads, and a resolution of 336×336 pixels for input images. Model may be trained on a large and diverse dataset of image-text pairs that learns a shared embedding space for visual and textual modalities. Using transformers allows the model to learn long-range dependencies and complex spatial relationships. A 768-dimensional vector representation per image (or text), can be derived from the model's final layer. CLIP embeddings may offer high multi modal alignment, semantic richness and domain generalization.

### Datasets

The OpenImages dataset v7 contains over 9 million natural images, annotated with image-level labels, object bounding boxes, object segmentation masks, visual relationships. Images are divided into train-validation-test datasets. For example, 6.69 million images may be used for the training set. Each image contains multiple class labels, with train dataset having about 20255 classes. This distribution is relevant when we pick classes for Setting 3 described above. We represent each image using models described above. For example, extracted representations may be of dimensions d=2048 for Resnet-50 and 768 for OpenAI CLIP-ViT-114-368. Embeddings may be scaled to be of unit-norm.

In a first aspect, the subject matter described in this specification can be embodied in methods that include accessing at least a part of a corpus of vectors that has been partitioned into vector datasets of different sizes, wherein the corpus of vectors has an order based on a similarity measure of a vector from the corpus of vectors with a query vector; forming a sample of the corpus of vectors by selecting, from at least two of the vector datasets, up to K vectors that are closest to an end of the order within their respective vector dataset, wherein K is an integer; sorting the vectors in the sample using the order based on the similarity measure; identifying a Kth vector selected from one of the vector datasets as a caboose vector in the sorted sample; determining an evaluation for at least one vector in the sample based on the similarity measure of that vector with the query vector; and determining an estimate based on a weighted sum of the evaluations, wherein: (a) evaluations for vectors appearing before the caboose vector in the sorted sample are multiplied by a first weight, (b) evaluations for vectors appearing after the caboose vector are multiplied by a second weight, and (c) the second weight is greater than the first weight.

In the first aspect, the second weight may be inversely proportional to a probability of assignment of vectors to a subset of the vector datasets, wherein the subset does not include the vector dataset that stores the caboose vector. In the first aspect, selecting up to K vectors from one of the vector datasets to form the sample may include invoking a nearest neighbor search of the one of the vector datasets to obtain up to K vectors stored in the vector dataset that have largest inner products with the query vector. In the first aspect, selecting up to K vectors from one of the vector datasets to form the sample may include invoking a nearest neighbor search of the one of the vector datasets to obtain up to K vectors stored in the vector dataset that have smallest Euclidean distances with the query vector. In the first aspect, the similarity measure may be an inner product. In the first aspect, the evaluation for at least one vector in the sample may be determined as an exponential function of the inner product of that vector with the query vector. In the first aspect, the evaluation for at least one vector in the sample may be determined as a sigmoid function of the inner product of that vector with the query vector. In the first aspect, the similarity measure may be a Euclidean distance. In the first aspect, the evaluation for at least one vector in the sample may be determined as a Gaussian function of the Euclidean distance of that vector with the query vector. In the first aspect, the methods may include generating a vector embedding of an image to be added to the corpus of vectors; randomly or pseudo-randomly assigning the vector embedding to one of the vector datasets; storing the vector embedding in the assigned vector dataset; and updating an index of the vector dataset to cover the vector embedding. In the first aspect, randomly assigning the vector embedding to one of the vector datasets may include drawing an integer from a geometric distribution. In the first aspect, the index of the vector dataset may be a hierarchical navigable small world index. In the first aspect, vectors in the corpus of vectors may have been randomly or pseudo-randomly assigned to individual vector datasets from amongst the vector datasets to implement the partition of the corpus of vectors. In the first aspect, the methods may include determining, based on the estimate, whether to continue training of a classifier that uses the query vector as a vector of classifier parameters. In the first aspect, the methods may include determining, based on the estimate, an indication of quality assessment of a classifier that uses the query vector as a vector of classifier parameters; and presenting the indication of quality assessment for the classifier in a user interface. In the first aspect, vectors in the corpus of vectors may be embeddings of images. In the first aspect, the query vector may be a logistic regression model. In the first aspect, the query vector may be used to implement a binary classifier. In the first aspect, the vector datasets may be respectively stored in vector databases that are indexed for accelerated nearest neighbor search using a graph-based nearest neighbor search or using a clustering-based nearest neighbor search.

In a second aspect, the subject matter described in this specification can be embodied in a computer-readable medium storing instructions operable to cause one or more processors to perform operations that include accessing at least a part of a corpus of vectors that has been partitioned into vector datasets of different sizes, wherein the corpus of vectors has an order based on a similarity measure of a vector from the corpus of vectors with a query vector; forming a sample of the corpus of vectors by selecting, from at least two of the vector datasets, up to K vectors that are closest to an end of the order within their respective vector dataset, wherein K is an integer; sorting the vectors in the sample using the order based on the similarity measure; identifying a Kth vector selected from one of the vector datasets as a caboose vector in the sorted sample; determining an evaluation for at least one vector in the sample based on the similarity measure of that vector with the query vector; and determining an estimate based on a weighted sum of the evaluations by adding to the estimate using a first weight to multiply evaluations for vectors appearing before the caboose vector in the sorted sample, and adding to the estimate using a second weight to multiply evaluations for vectors appearing after the caboose vector in the sorted sample, wherein the second weight is greater than the first weight.

In the second aspect, the second weight may be inversely proportional to a probability of assignment of vectors to a subset of the vector datasets, wherein the subset does not include the vector dataset that stores the caboose vector. In the second aspect, selecting up to K vectors from one of the vector datasets to form the sample may include invoking a nearest neighbor search of the one of the vector datasets to obtain up to K vectors stored in the vector dataset that have largest inner products with the query vector. In the second aspect, selecting up to K vectors from one of the vector datasets to form the sample may include invoking a nearest neighbor search of the one of the vector datasets to obtain up to K vectors stored in the vector dataset that have smallest Euclidean distances with the query vector. In the second aspect, the similarity measure may be an inner product. In the second aspect, the evaluation for at least one vector in the sample may be determined as an exponential function of the inner product of that vector with the query vector. In the second aspect, the evaluation for at least one vector in the sample may be determined as a sigmoid function of the inner product of that vector with the query vector. In the second aspect, the similarity measure may be a Euclidean distance. In the second aspect, the evaluation for at least one vector in the sample may be determined as a Gaussian function of the Euclidean distance of that vector with the query vector. In the second aspect, the operations may include generating a vector embedding of an image to be added to the corpus of vectors; randomly or pseudo-randomly assigning the vector embedding to one of the vector datasets; storing the vector embedding in the assigned vector dataset; and updating an index of the vector dataset to cover the vector embedding. In the second aspect, randomly assigning the vector embedding to one of the vector datasets may include drawing an integer from a geometric distribution. In the second aspect, the index of the vector dataset may be a hierarchical navigable small world index. In the second aspect, vectors in the corpus of vectors may have been randomly or pseudo-randomly assigned to individual vector datasets from amongst the vector datasets to implement the partition of the corpus of vectors. In the second aspect, the operations may include determining, based on the estimate, whether to continue training of a classifier that uses the query vector as a vector of classifier parameters. In the second aspect, the operations may include determining, based on the estimate, an indication of quality assessment of a classifier that uses the query vector as a vector of classifier parameters; and presenting the indication of quality assessment for the classifier in a user interface. In the second aspect, vectors in the corpus of vectors may be embeddings of images. In the second aspect, the query vector may be a logistic regression model. In the second aspect, the query vector may be used to implement a binary classifier. In the second aspect, the vector datasets may be respectively stored in vector databases that are indexed for accelerated nearest neighbor search using a graph-based nearest neighbor search or using a clustering-based nearest neighbor search.

In a third aspect, the subject matter described in this specification can be embodied in systems that include a memory subsystem; and processing circuitry configured to execute instructions stored in the memory subsystem to perform operations comprising: accessing at least a part of a corpus of vectors that has been partitioned into vector datasets of different sizes, wherein the corpus of vectors has an order based on a similarity measure of a vector from the corpus of vectors with a query vector; forming a sample of the corpus of vectors by selecting, from at least two of the vector datasets, up to K vectors that are closest to an end of the order within their respective vector dataset, wherein K is an integer; sorting the vectors in the sample using the order based on the similarity measure; identifying a Kth vector selected from one of the vector datasets as a caboose vector in the sorted sample; determining an evaluation for at least one vector in the sample based on the similarity measure of that vector with the query vector; and determining an estimate based on a weighted sum of the evaluations by adding to the estimate using a first weight to multiply evaluations for vectors appearing before the caboose vector in the sorted sample, and adding to the estimate using a second weight to multiply evaluations for vectors appearing after the caboose vector in the sorted sample, wherein the second weight is greater than the first weight.

In the third aspect, the second weight may be inversely proportional to a probability of assignment of vectors to a subset of the vector datasets, wherein the subset does not include the vector dataset that stores the caboose vector. In the third aspect, selecting up to K vectors from one of the vector datasets to form the sample may include invoking a nearest neighbor search of the one of the vector datasets to obtain up to K vectors stored in the vector dataset that have largest inner products with the query vector. In the third aspect, selecting up to K vectors from one of the vector datasets to form the sample may include invoking a nearest neighbor search of the one of the vector datasets to obtain up to K vectors stored in the vector dataset that have smallest Euclidean distances with the query vector. In the third aspect, the similarity measure may be an inner product. In the third aspect, the evaluation for at least one vector in the sample may be determined as an exponential function of the inner product of that vector with the query vector. In the third aspect, the evaluation for at least one vector in the sample may be determined as a sigmoid function of the inner product of that vector with the query vector. In the third aspect, the similarity measure may be a Euclidean distance. In the third aspect, the evaluation for at least one vector in the sample may be determined as a Gaussian function of the Euclidean distance of that vector with the query vector. In the third aspect, the operations may include generating a vector embedding of an image to be added to the corpus of vectors; randomly or pseudo-randomly assigning the vector embedding to one of the vector datasets; storing the vector embedding in the assigned vector dataset; and updating an index of the vector dataset to cover the vector embedding. In the third aspect, randomly assigning the vector embedding to one of the vector datasets may include drawing an integer from a geometric distribution. In the third aspect, the index of the vector dataset may be a hierarchical navigable small world index. In the third aspect, vectors in the corpus of vectors may have been randomly or pseudo-randomly assigned to individual vector datasets from amongst the vector datasets to implement the partition of the corpus of vectors. In the third aspect, the operations may include determining, based on the estimate, whether to continue training of a classifier that uses the query vector as a vector of classifier parameters. In the third aspect, the operations may include determining, based on the estimate, an indication of quality assessment of a classifier that uses the query vector as a vector of classifier parameters; and presenting the indication of quality assessment for the classifier in a user interface. In the third aspect, vectors in the corpus of vectors may be embeddings of images. In the third aspect, the query vector may be a logistic regression model. In the third aspect, the query vector may be used to implement a binary classifier. In the third aspect, the vector datasets may be respectively stored in vector databases that are indexed for accelerated nearest neighbor search using a graph-based nearest neighbor search or using a clustering-based nearest neighbor search.

In a fourth aspect, the subject matter described in this specification can be embodied in methods that include accessing at least a part of a corpus of vectors that has been partitioned into vector datasets of different sizes, wherein the corpus of vectors has an order based on a similarity measure of a vector from the corpus of vectors with a query vector; forming a sample of the corpus of vectors by selecting, from at least two of the vector datasets, up to K vectors that are closest to an end of the order within their respective vector dataset, wherein K is an integer, and wherein the vectors of the sample from one of the vector datasets are selected using a graph-based nearest neighbor search or using a clustering-based nearest neighbor search; determining an evaluation for at least one vector in the sample based on the similarity measure of that vector with the query vector; and determining an estimate based on a weighted sum of the evaluations, wherein determining the estimate comprises applying a weight to one of the evaluations that is inversely proportional to a probability of assignment of vectors to a subset of the vector datasets.

In the fourth aspect, selecting up to K vectors from one of the vector datasets to form the sample may include invoking a nearest neighbor search of the one of the vector datasets to obtain up to K vectors stored in the vector dataset that have largest inner products with the query vector. In the fourth aspect, selecting up to K vectors from one of the vector datasets to form the sample may include: invoking a nearest neighbor search of the one of the vector datasets to obtain up to K vectors stored in the vector dataset that have smallest Euclidean distances with the query vector. In the fourth aspect, the similarity measure may be an inner product. In the fourth aspect, the evaluation for at least one vector in the sample may be determined as an exponential function of the inner product of that vector with the query vector. In the fourth aspect, the evaluation for at least one vector in the sample may be determined as a sigmoid function of the inner product of that vector with the query vector. In the fourth aspect, the similarity measure may be a Euclidean distance. In the fourth aspect, the evaluation for at least one vector in the sample may be determined as a Gaussian function of the Euclidean distance of that vector with the query vector. In the fourth aspect, the methods ma include generating a vector embedding of an image to be added to the corpus of vectors; randomly or pseudo-randomly assigning the vector embedding to one of the vector datasets; storing the vector embedding in the assigned vector dataset; and updating an index of the vector dataset to cover the vector embedding. In the fourth aspect, randomly assigning the vector embedding to one of the vector datasets comprises drawing an integer from a geometric distribution. In the fourth aspect, the index of the vector dataset may be a hierarchical navigable small world index. In the fourth aspect, vectors in the corpus of vectors have been randomly or pseudo-randomly assigned to individual vector datasets from amongst the vector datasets to implement the partition of the corpus of vectors. In the fourth aspect, the methods may include determining, based on the estimate, whether to continue training of a classifier that uses the query vector as a vector of classifier parameters. In the fourth aspect, the methods may include determining, based on the estimate, an indication of quality assessment of a classifier that uses the query vector as a vector of classifier parameters; and presenting the indication of quality assessment for the classifier in a user interface. In the fourth aspect, the vectors in the corpus of vectors may be embeddings of images. In the fourth aspect, selecting the query vector may be a logistic regression model. In the fourth aspect, the query vector may be used to implement a binary classifier. In the fourth aspect, the vector datasets may be respectively stored in vector databases that are indexed for accelerated nearest neighbor search using a graph-based nearest neighbor search or using a clustering-based nearest neighbor search.

In a fifth aspect, the subject matter described in this specification can be embodied in methods for assessing quality of a classifier that include accessing at least a part of a corpus of vectors that has been partitioned into vector datasets of different sizes, wherein the corpus of vectors has an order based on an inner product of a vector from the corpus of vectors with a vector of classifier parameters; forming a sample of the corpus of vectors by selecting, from at least two of the vector datasets, up to K vectors that are closest to an end of the order within their respective vector dataset, wherein K is an integer; identifying vectors in the sample satisfying a condition that compares an inner product of a vector from the corpus of vectors with a vector of classifier parameters to a threshold; and determining an estimate of a count of vectors satisfying the condition in the corpus of vectors based on a weighted count of the identified vectors in the sample.

In the fifth aspect, selecting up to K vectors from one of the vector datasets to form the sample may include invoking a nearest neighbor search of the one of the vector datasets to obtain up to K vectors stored in the vector dataset that have largest inner products with the vector of classifier parameters. In the fifth aspect, determining an estimate of a count of vectors satisfying the condition in the corpus of vectors comprises applying a weight to one of the identified vectors that is inversely proportional to a probability of assignment of vectors to a subset of the vector datasets. In the fifth aspect, identifying vectors in the sample satisfying the condition comprises sorting the vectors in the sample using the order based on the inner product; and identifying a last vector in the sorted sample that satisfies the condition. In the fifth aspect, determining the estimate of the count of vectors satisfying the condition in the corpus of vectors may include identifying a Kth vector selected from one of the vector datasets as a caboose vector in the sorted sample. In the fifth aspect, the methods may include adding to the estimate of the count of vectors satisfying the condition in the corpus of vectors using a first weight for vectors appearing before the caboose vector in the sorted sample; and adding to the estimate of the count of vectors satisfying the condition in the corpus of vectors using a second weight for vectors appearing after the caboose vector in the sorted sample, wherein the second weight is greater than the first weight. In the fifth aspect, the second weight is inversely proportional to a probability of assignment of vectors to a subset of the vector datasets, wherein the subset does not include the vector dataset that stores the caboose vector. In the fifth aspect, the methods may include generating a vector embedding of an image to be added to the corpus of vectors; randomly or pseudo-randomly assigning the vector embedding to one of the vector datasets; storing the vector embedding in the assigned vector dataset; and updating an index of the vector dataset to cover the vector embedding.

In a sixth aspect, the subject matter described in this specification can be embodied in a computer-readable medium storing instructions operable to cause one or more processors to perform operations that include accessing a set of vector datasets that collectively store a partition of a corpus of vectors into vector datasets of different sizes, wherein the corpus of vectors is ordered based on an inner product of a vector from the corpus of vectors with a vector of classifier parameters; selecting up to K vectors from each of the vector datasets in the set of vector datasets to form a sample of the corpus of vectors, wherein the selected vectors are selected from one end of the order based on the inner product within their respective vector dataset, and wherein K is an integer; identifying vectors in the sample satisfying a condition that compares an inner product of a vector from the corpus of vectors with a vector of classifier parameters to a threshold; and determining an estimate of a count of vectors satisfying the condition in the corpus of vectors based on a weighted count of the identified vectors in the sample.

In the sixth aspect, selecting up to K vectors from one of the vector datasets in the set of vector datasets to form the sample may include invoking a nearest neighbor search of the one of the vector datasets to obtain up to K vectors stored in the vector dataset that have largest inner products with the vector of classifier parameters. In the sixth aspect, identifying vectors in the sample satisfying the condition may include: sorting the vectors in the sample using the order based on the inner product; and identifying a last vector in the sorted sample that satisfies the condition. In the sixth aspect, determining the estimate of the count of vectors satisfying the condition in the corpus of vectors may include: identifying a Kth vector selected from one of the vector datasets as a caboose vector in the sorted sample; adding to the estimate of the count of vectors satisfying the condition in the corpus of vectors using a first weight for vectors appearing before the caboose vector in the sorted sample; and adding to the estimate of the count of vectors satisfying the condition in the corpus of vectors using a second weight for vectors appearing after the caboose vector in the sorted sample, wherein the second weight is greater than the first weight. In the sixth aspect, the second weight may be inversely proportional to a probability of assignment of vectors to a subset of the set of vector datasets, wherein the subset does not include the vector dataset that stores the caboose vector. In the sixth aspect, the operations further comprise generating a vector embedding of an image to be added to the corpus of vectors; randomly assigning the vector embedding to one of the vector datasets in the set of vector datasets; storing the vector embedding in the assigned vector dataset; and updating an index of the vector dataset to cover the vector embedding. In the sixth aspect, randomly assigning the vector embedding to one of the vector datasets in the set of vector datasets may include drawing an integer from a geometric distribution. In the sixth aspect, the index of the vector dataset may be a hierarchical navigable small world index. In the sixth aspect, vectors in the corpus of vectors have been randomly or pseudo-randomly assigned to vector datasets in the set of vector datasets to implement the partition of the corpus of vectors. In the sixth aspect, the operations further comprise: determining whether to continue training of a classifier that uses the vector of classifier parameters based on the estimate of the count of vectors satisfying the condition in the corpus of vectors. In the sixth aspect, vectors in the corpus of vectors are embeddings of images. In the sixth aspect, the vector of classifier parameters may be a regression model. In the sixth aspect, the vector of classifier parameters may be used to implement a binary classifier. In the sixth aspect, the threshold corresponds to a classification probability estimate determined by using the vector of classifier parameters.

In a seventh aspect, the subject matter described in this specification can be embodied in systems that include a memory subsystem; and processing circuitry configured to execute instructions stored in the memory subsystem to perform operations comprising: accessing a set of vector datasets that collectively store a partition of a corpus of vectors into vector datasets of different sizes, wherein the corpus of vectors is ordered based on an inner product of a vector from the corpus of vectors with a vector of classifier parameters; selecting up to K vectors from each of the vector datasets in the set of vector datasets to form a sample of the corpus of vectors, wherein the selected vectors are selected from one end of the order based on the inner product within their respective vector dataset, and wherein K is an integer; identifying vectors in the sample satisfying a condition that compares an inner product of a vector from the corpus of vectors with a vector of classifier parameters to a threshold; and determining an estimate of a count of vectors satisfying the condition in the corpus of vectors based on a weighted count of the identified vectors in the sample.

In the seventh aspect, selecting up to K vectors from one of the vector datasets in the set of vector datasets to form the sample may include invoking a nearest neighbor search of the one of the vector datasets to obtain up to K vectors stored in the vector dataset that have largest inner products with the vector of classifier parameters. In the seventh aspect, identifying vectors in the sample satisfying the condition may include: sorting the vectors in the sample using the order based on the inner product; and identifying a last vector in the sorted sample that satisfies the condition. In the seventh aspect, determining the estimate of the count of vectors satisfying the condition in the corpus of vectors may include: identifying a Kth vector selected from one of the vector datasets as a caboose vector in the sorted sample; adding to the estimate of the count of vectors satisfying the condition in the corpus of vectors using a first weight for vectors appearing before the caboose vector in the sorted sample; and adding to the estimate of the count of vectors satisfying the condition in the corpus of vectors using a second weight for vectors appearing after the caboose vector in the sorted sample, wherein the second weight is greater than the first weight. In the seventh aspect, the second weight may be inversely proportional to a probability of assignment of vectors to a subset of the set of vector datasets, wherein the subset does not include the vector dataset that stores the caboose vector. In the seventh aspect, the operations further comprise generating a vector embedding of an image to be added to the corpus of vectors; randomly assigning the vector embedding to one of the vector datasets in the set of vector datasets; storing the vector embedding in the assigned vector dataset; and updating an index of the vector dataset to cover the vector embedding. In the seventh aspect, randomly assigning the vector embedding to one of the vector datasets in the set of vector datasets may include drawing an integer from a geometric distribution. In the seventh aspect, the index of the vector dataset may be a hierarchical navigable small world index. In the seventh aspect, vectors in the corpus of vectors have been randomly or pseudo-randomly assigned to vector datasets in the set of vector datasets to implement the partition of the corpus of vectors. In the seventh aspect, the operations further comprise: determining whether to continue training of a classifier that uses the vector of classifier parameters based on the estimate of the count of vectors satisfying the condition in the corpus of vectors. In the seventh aspect, vectors in the corpus of vectors are embeddings of images. In the seventh aspect, the vector of classifier parameters may be a regression model. In the seventh aspect, the vector of classifier parameters may be used to implement a binary classifier. In the seventh aspect, the threshold corresponds to a classification probability estimate determined by using the vector of classifier parameters.

In an eighth aspect, the subject matter described in this specification can be embodied in at least one apparatus comprising: means for accessing a set of vector datasets that collectively store a partition of a corpus of vectors into vector datasets of different sizes, wherein the corpus of vectors is ordered based on an inner product of a vector from the corpus of vectors with a vector of classifier parameters; means for selecting up to K vectors from each of the vector datasets in the set of vector datasets to form a sample of the corpus of vectors, wherein the selected vectors are selected from one end of the order based on the inner product within their respective vector dataset, and wherein K is an integer; means for identifying vectors in the sample satisfying a condition that compares an inner product of a vector from the corpus of vectors with a vector of classifier parameters to a threshold; and means for determining an estimate of a count of vectors satisfying the condition in the corpus of vectors based on a weighted count of the identified vectors in the sample.

In the eighth aspect, the vector datasets may be respectively stored in vector databases that are indexed for accelerated nearest neighbor search.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively, or in addition, the memory subsystem may include data or instructions that are hard-wired into processing circuitry. The memory subsystem may include a single memory unit or multiple joint or disjoint memory units, which each of the multiple joint or disjoint memory units storing all or a portion of the data described as being stored in the memory subsystem.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

As used herein, the term “and/or” encompasses its plain and ordinary meaning and may refer to an intersection or a union of sets of data. For example, the phrase “A and/or B” encompasses the union of A and B. The phrase “A and/or B” encompasses the intersection of A and B.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for assessing quality of a classifier, the method comprising:
accessing at least a part of a corpus of vectors that has been partitioned into vector datasets of different sizes, wherein the corpus of vectors has an order based on an inner product of a vector from the corpus of vectors with a vector of classifier parameters;
forming a sample of the corpus of vectors by selecting, from at least two of the vector datasets, up to K vectors that are closest to an end of the order within their respective vector dataset, wherein K is an integer;
identifying vectors in the sample satisfying a condition that compares an inner product of a vector from the corpus of vectors with a vector of classifier parameters to a threshold; and
determining an estimate of a count of vectors satisfying the condition in the corpus of vectors based on a weighted count of the identified vectors in the sample.

2. The method of claim 1, wherein selecting up to K vectors from one of the vector datasets to form the sample comprises:
invoking a nearest neighbor search of the one of the vector datasets to obtain up to K vectors stored in the vector dataset that have largest inner products with the vector of classifier parameters.

3. The method of claim 1, wherein determining an estimate of a count of vectors satisfying the condition in the corpus of vectors comprises applying a weight to one of the identified vectors that is inversely proportional to a probability of assignment of vectors to a subset of the vector datasets.

4. The method of claim 1, wherein identifying vectors in the sample satisfying the condition comprises:
sorting the vectors in the sample using the order based on the inner product; and
identifying a last vector in the sorted sample that satisfies the condition.

5. The method of claim 4, wherein determining the estimate of the count of vectors satisfying the condition in the corpus of vectors comprises:
identifying a Kth vector selected from one of the vector datasets as a caboose vector in the sorted sample;
adding to the estimate of the count of vectors satisfying the condition in the corpus of vectors using a first weight for vectors appearing before the caboose vector in the sorted sample; and
adding to the estimate of the count of vectors satisfying the condition in the corpus of vectors using a second weight for vectors appearing after the caboose vector in the sorted sample, wherein the second weight is greater than the first weight.

6. The method of claim 5, wherein the second weight is inversely proportional to a probability of assignment of vectors to a subset of the vector datasets, wherein the subset does not include the vector dataset that stores the caboose vector.

7. The method of claim 1, further comprising:
generating a vector embedding of an image to be added to the corpus of vectors;
randomly or pseudo-randomly assigning the vector embedding to one of the vector datasets;
storing the vector embedding in the assigned vector dataset; and
updating an index of the vector dataset to include the vector embedding.

8. The method of claim 7, wherein randomly assigning the vector embedding to one of the vector datasets comprises drawing an integer from a geometric distribution.

9. The method of claim 7, wherein the index of the vector dataset is a hierarchical navigable small world index.

10. The method of claim 1, wherein vectors in the corpus of vectors have been randomly or pseudo-randomly assigned to individual vector datasets from amongst the vector datasets to implement the partition of the corpus of vectors.

11. The method of claim 1, further comprising:
determining whether to continue training of a classifier that uses the vector of classifier parameters based on the estimate of the count of vectors satisfying the condition in the corpus of vectors.

12. The method of claim 1, further comprising:
determining an indication of quality assessment of a classifier that uses the vector of classifier parameters based on the estimate of the count of vectors satisfying the condition in the corpus of vectors; and
presenting the indication of quality assessment for the classifier in a user interface.

13. The method of claim 1, wherein vectors in the corpus of vectors are embeddings of images.

14. The method of claim 1, wherein the vector of classifier parameters is used to implement a binary classifier.

15. The method of claim 1, wherein the threshold corresponds to a classification probability estimate determined by using the vector of classifier parameters.

16. A system, comprising:
a memory subsystem; and
processing circuitry configured to execute instructions stored in the memory subsystem to perform operations comprising:
accessing a set of vector datasets that collectively store a partition of a corpus of vectors into vector datasets of different sizes, wherein the corpus of vectors is ordered based on an inner product of a vector from the corpus of vectors with a vector of classifier parameters;
selecting up to K vectors from each of the vector datasets in the set of vector datasets to form a sample of the corpus of vectors, wherein the selected vectors are selected from one end of the order based on the inner product within their respective vector dataset, and wherein K is an integer;
identifying vectors in the sample satisfying a condition that compares an inner product of a vector from the corpus of vectors with a vector of classifier parameters to a threshold; and
determining an estimate of a count of vectors satisfying the condition in the corpus of vectors based on a weighted count of the identified vectors in the sample.

17. The system of claim 16, wherein identifying vectors in the sample satisfying the condition comprises:
sorting the vectors in the sample using the order based on the inner product; and
identifying a last vector in the sorted sample that satisfies the condition.

18. The system of claim 17, wherein determining the estimate of the count of vectors satisfying the condition in the corpus of vectors comprises:
identifying a Kth vector selected from one of the vector datasets as a caboose vector in the sorted sample;
adding to the estimate of the count of vectors satisfying the condition in the corpus of vectors using a first weight for vectors appearing before the caboose vector in the sorted sample; and
adding to the estimate of the count of vectors satisfying the condition in the corpus of vectors using a second weight for vectors appearing after the caboose vector in the sorted sample, wherein the second weight is greater than the first weight.

19. The system of claim 16, the operations further comprising:
determining whether to continue training of a classifier that uses the vector of classifier parameters based on the estimate of the count of vectors satisfying the condition in the corpus of vectors.

20. A computer-readable medium storing instructions operable to cause one or more processors to perform operations comprising:
accessing a set of vector datasets that collectively store a partition of a corpus of vectors into vector datasets of different sizes, wherein the corpus of vectors is ordered based on an inner product of a vector from the corpus of vectors with a vector of classifier parameters;
selecting up to K vectors from each of the vector datasets in the set of vector datasets to form a sample of the corpus of vectors, wherein the selected vectors are selected from one end of the order based on the inner product within their respective vector dataset, and wherein K is an integer;
identifying vectors in the sample satisfying a condition that compares an inner product of a vector from the corpus of vectors with a vector of classifier parameters to a threshold; and
determining an estimate of a count of vectors satisfying the condition in the corpus of vectors based on a weighted count of the identified vectors in the sample.
